(19) United States
(12) Patent Application Publication
(10) Pub. No.: US 2009/0021830 A1
(43) Pub. Date: Jan. 22, 2009

(54) PROJECTION LENS OF A MICROLITHOGRAPHIC EXPOSURE SYSTEM

(75) Inventors: Michael Totzeck, Schwaebisch Gmuend (DE); Susanne Beder, Aalen (DE); Wilfried Clauss, Tuebingen (DE); Heiko Feldmann, Aalen (DE); Daniel Kraehmer, Essingen (DE); Aurelian Dodoc, Heidenheim (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 12/132,796

(22) Filed: Jun. 4, 2008

Related U.S. Application Data
(63) Continuation-in-part of application No. 12/042,621, filed on Mar. 5, 2008.
Application No. 12/042,621 is a continuation of application No. PCT/EP2006/066332, filed on Sep. 13, 2006.
(60) Provisional application No. 60/717,576, filed on Sep. 14, 2005.
(60) Provisional application No. 60/942,231, filed on Jun. 6, 2007.

(30) Foreign Application Priority Data
Jun. 6, 2007 (DE) 10 2007 026 845.0

(51) Int. Cl. G02B 17/08; G02B 27/28; G02B 27/18

(52) U.S. Cl. 359/499; 359/494; 359/497

(57) ABSTRACT

In some embodiments, the disclosure provides a projection lens configured to configured to image radiation from an object plane of the projection lens to an image plane of the projection lens. The projection lens can, for example, be used in a microlithographic projection exposure apparatus. The projection lens includes a last lens on the image plane side. The last lens includes at least one intrinsically birefringent material. The material can be, for example, magnesium oxide, a garnet, lithium barium fluoride and/or a spinel. The last lens can have a thickness d which satisfies the condition 0.8*y_{0, max}<d<1.5*y_{0, max}, where y_{0, max} denotes the maximum distance of an object field point from the optical axis.

### CROSS-REFERENCE TO RELATED APPLICATIONS

The present application is a continuation-in-part application of, and claims priority under 35 USC §120 to, U.S. Ser. No. 12/042,621, filed Mar. 5, 2008, which is a continuation of, and claims priority under 35 USC § 120 to, international application PCT/EP2006/066332, filed Sep. 13, 2006, which claims benefit of U.S. Ser. No. 60/717,576, filed Sep. 14, 2005. The present application also claims priority under 35 USC § 119(e)(1) to U.S. Ser. No. 60/942,231, filed Jun. 6, 2007. The present application further claims priority under 35 USC § 119 to DE 10 2007 026 845.0, filed on Jun. 6, 2007. The entire contents of each of these applications is incorporated herein by reference.

### FIELD

The present disclosure relates to a projection lens of a microlithographic exposure system, as well as related systems, subsystems, components and methods.

### BACKGROUND

Microlithography is used in the fabrication of microstructured components like integrated circuits, LCD's and other microstructured devices. The microlithographic process is performed in a so-called microlithographic exposure system including an illumination system and a projection lens. The image of a mask (or reticle) being illuminated by the illumination system is projected, through the projection lens, onto a resist-covered substrate, typically a silicon wafer bearing one or more light-sensitive layers and being provided in the image plane of the projection lens, in order to transfer the circuit pattern onto the light-sensitive layers on the wafer.

### SUMMARY

Attempts to enhance the resolution and the optical performance of microlithographic exposure systems can lead to an increasing desire for use of optical components including materials with relatively high refractive index. Herein, a refractive index is regarded as “high” if its value exceeds, at the used wavelength, the refractive index of SiO₂ which is n≈1.56 at 193 nm. Such materials are, for example, spinelle (n≈1.87 at 193 nm), sapphire (n≈1.93 at 193 nm) or magnesium oxide (n≈2.02 at 193 nm). However, problems can arise from the fact that these materials exhibit the effect of either uniaxial birefringence (e.g., sapphire, being optically uniaxial with Δn≈−0.01 at 193 nm) or intrinsic birefringence (“IBR”, e.g., spinelle with an IBR of √52 nm/cm at 193 nm or magnesium oxide with an IBR of ≈70 nm/cm at 193 nm, or garnets (M1)₃(M2)₇O₁₂ with M1 for instance Y, Sc or Lu, with M2 for instance Al, Ga, In or Tl, and an IBR in a range between 20 nm/cm and 80 nm/cm), causing a retardation that disturbs the polarization distribution of the transmitted rays. Further disturbances can arise, for example, from stress birefringence in the used optical components, phase shifts occurring at reflecting boundaries etc.

Accordingly, countermeasures are desirable to at least partially compensate for such disturbances.

In some embodiments, the present disclosure provides a projection lens of a microlithographic projection exposure apparatus, which permits compensation of the adverse influence of intrinsic birefringence when using highly refractive crystal materials while limiting a disturbing influence of the compensation on optical imaging or what is referred to as the scalar phase.

In certain embodiments, the disclosure provides a projection lens of a microlithographic projection exposure apparatus for producing the image of a mask which can be positioned in an object plane on a light-sensitive layer which can be positioned in an image plane. The projection lens has an optical axis and includes:
a plurality of refractive lenses of non-optically uniaxial material, wherein at least one of the lenses has intrinsic birefringence; and
at least two compensation elements for at least partial compensation of the intrinsic birefringence, wherein the compensation elements each have a respective optically uniaxial crystal material;
wherein at least one of the compensation elements does not introduce a retardation for light passing through in the direction of the optical axis; and
wherein the at least two compensation elements are arranged along the optical axis at different positions, between which there is at least one of the refractive lenses of non-optically uniaxial material.

The term ‘optical axis’ is used in the context of the present application to denote a straight line or a succession of straight line portions extending through the centers of curvature of the rotationally symmetrical optical components of the projection lens.

The term ‘retardation’ is used to denote the difference in the optical paths of two orthogonal polarization states.

In accordance with the disclosure therefore a plurality of compensation elements can be used, including at least two but in some cases at least three or more compensation elements.

In certain embodiments at least one of the compensation elements has a plane-parallel geometry. In that respect, in the sense of the present application, a plane-parallel geometry is afforded or there is a plane-parallel plate when the planarity over the entire optically effective surface of the element in question is better than λ/20 (e.g., better than λ/30, better than λ/50) measured for example at a wavelength of λ=546 nm.

An aspect of the present disclosure is based on the realization that IBR compensation can also be effected by a plurality of compensation elements of optically uniaxial crystal material arranged at different suitable positions along the optical axis, wherein those compensation elements can be of such a configuration that, in that compensation situation, due to the surface shape of the compensation element, no disturbing influence is exerted on optical imaging or what is referred to as the scalar phase, as occurs for example when using a birefringent or optically active compensation element of variable thickness profile. Rather, with the use according to the disclosure of a plurality of compensation elements of optically uniaxial crystal material, IBR compensation may not occur by way of a given surface shape or a varying thickness profile, but may occur by way of the angle distribution in the beam and by way of the suitable positioning of such compensation elements in the beam path, wherein the compensation elements according to the disclosure do not destructively contribute to optical imaging by virtue of their surface shape itself.

In that respect the disclosure is based on the consideration that in a uniaxial crystal the refractive index acting on the light beam depends both on the beam direction and also on the orientation of the optical crystal axis in the optically uniaxial crystal material. For a plane-parallel plate the geometrical path L of a light beam in the plate is given by:

L(α)=n(α)*d/[n(α)²−sin² α]^{1/2} (1)

Accordingly the retardation RET is a function of the angle of incidence α

RET(α)=2*π/L(α)*[nₒ−n(α)]*L(α) (2)

wherein α denotes the angle of incidence, d denotes the thickness of the plate and nₒ denotes the ordinary refractive index of the crystal material. For MgF₂ nₒ at a wavelength of 193 nm is approximately of a value of 1.427. At the various positions in the projection lens the light beams within a beam pencil now have a specific angle distribution. In the case of a telecentric beam path in the object and image space the angle distributions for each beam pencil are virtually identical and virtually symmetrical around the principal ray. In the interior of the system the angle distributions of various pencils are different. Within a pencil the ray directions are no longer symmetrical relative to the principal ray. The introduction of a correction or compensation element into such an air space means that all pencils are influenced differently by the compensation effect. With a plurality of correction or compensation elements at different positions, it is accordingly possible to achieve a marked reduction in the IBR-induced retardation (for example a highly refractive last lens at the image plane side).

Furthermore use of the above-mentioned compensation elements according to the disclosure is also advantageous from points of view of production engineering insofar as comparatively simple manufacture of such compensation elements can be achieved by firstly a plate including an optically uniaxial material being wrung on to one or both side faces of an optically isotropic carrier plate and the plate of optically uniaxial material then being processed or removed to set the desired thickness.

In certain embodiments the at least one compensation element has two plane-parallel subelements of optically uniaxial crystal material whose optical crystal axes are respectively arranged in a plane perpendicular to the optical axis and rotated relative to each other about the optical axis, optionally through an angle of 90°. With that design configuration of the compensation element it can be provided that accordingly due to the joint action of the subelements only a slight retardation or (in the case of equal thicknesses of the two subelements) no retardation is induced along the optical axis OA of the projection lens by the compensation element.

In certain embodiments the two subelements are disposed on mutually opposite side faces of a plane-parallel carrier element of optically isotropic material.

In certain embodiments the two subelements are substantially of the same thickness.

In certain embodiments at least one of the compensation elements is so arranged that at least one respective lens is disposed between the compensation element and a field plane and between the compensation element and a pupil plane of the projection lens.

In certain embodiments at least one such compensation element is arranged at a position along the optical axis, at which the beam path extends substantially telecentrically. As the polarization-influencing action of such a compensation element in such a region is field-independent that compensation element is suitable in particular for the compensation of IBR contributions with a constant field configuration. Such a compensation element can be arranged in particular between the object plane and a lens of the projection lens which is first from the object plane and which has a refractive power.

In certain embodiments at least one of the compensation elements is arranged between the object plane and a refractive lens of the projection lens, the refractive lens directly following the object plane.

In certain embodiments at least one of the compensation elements is arranged in a last optical subsystem, at the image plane side, of the projection lens.

In certain embodiments at least one compensation element in the optical subsystem of the projection lens, that is last at the image plane side, is disposed in the proximity of a pupil plane. The principal ray height at the position in question can be referred to as the criterion for the proximity in relation to the pupil plane. If it is borne in mind that the principal ray height is zero in the pupil plane itself, then the expression ‘in the proximity of the pupil plane’ embraces such positions in which the principal ray height is at a maximum 10% of the optically effective diameter of the optical element at that position. At such a position close to the pupil the angles of the marginal rays differ from each other little or the principal ray is of a relatively small height. A compensation element arranged at such a position is suitable in particular for compensating for IBR contributions with a variable field configuration, that is to say for inducing a field-dependent retardation or compensation of an IBR varying over the field.

In certain embodiments at least three such compensation elements are arranged along the optical axis. When such a design configuration is involved, having a multiplicity of compensation elements at a multiplicity of suitable positions in the projection lens, it can be provided in particular that compensation of the retardation caused by the lens which has intrinsic birefringence is implemented exclusively by such compensation elements. In that case therefore the entire polarization-optical compensation of the imaging system can be achieved by substantially refractive power-less compensation elements and without disturbing optical imaging or the scalar phase.

In certain embodiments at least one of the refractive lenses causes a maximum retardation of at least 25 nm/cm as a consequence of intrinsic birefringence.

In certain embodiments the at least one refractive lens which involves intrinsic birefringence is made from a material selected from the group which includes magnesium oxide (MgO), garnets, in particular lutetium aluminum garnet (Lu₃Al₅O₁₂, LuAG), lithium barium fluoride (LiBaF₃) and spinel, in particular magnesium spinel (MgAl₂O₄).

In certain embodiments the at least one refractive lens which involves intrinsic birefringence is a last lens at the image plane side of the projection lens.

In certain embodiments the optical element which is last at the image plane side is of a comparatively large radius, which can also lead to a great thickness. The following condition can be referred to as the criterion for that thickness:

0.8*y_{0, max}<d<1.5*y_{0, max} (3)

wherein y_{0,max} denotes the maximum object height, that is to say the maximum distance of an object field point from the optical axis.

In that way it is possible to reduce the field dependency of the retardation caused by the IBR in that last lens or the dependency of the polarization disturbance caused by that lens on the field height. That is particularly advantageous precisely in connection with the concept according to the disclosure of IBR compensation as a strongly field-dependent polarization disturbance is generally particularly difficult to compensate while a system with a polarization disturbance involving a low level of field dependency is particularly accessible for IBR compensation according to the disclosure via weakly refractive elements and in particular plane plates of optically uniaxial material or can be substantially or completely compensated by those compensation elements without further elements or measures having a polarization-optical effect (such as for example the clocking of lenses).

In certain embodiments the projection lens has a last lens at the image plane side which is composed of at least four lens elements of intrinsically birefringent material and arranged in succession along the optical axis, wherein two respective ones of the four lens elements in pairs have the same crystal cut and are arranged rotated relative to each other about the optical axis.

In certain embodiments two of the four lens elements have a [100]-crystal cut and the other two lens elements of the four lens elements have a [100]-crystal cut.

In certain embodiments compensation for the retardation caused by the lens which involves intrinsic birefringence is implemented exclusively by the compensation elements.

In certain embodiments at least one of the compensation elements has an optically uniaxial crystal material whose optical crystal axis is arranged parallel to the optical axis.

In certain embodiments the compensation element has a subelement of optically uniaxial crystal material, which is disposed on a plane-parallel carrier plate of optically isotropic material.

In certain embodiments the optically isotropic material is quartz glass.

In certain embodiments the optically uniaxial material is magnesium fluoride (MgF₂).

In certain embodiments the projection lens has at least one refractive subsystem and produces at least one intermediate image.

In certain embodiments the projection lens has at least one concave mirror.

In certain embodiments the projection lens has precisely two concave mirrors.

In certain embodiments the projection lens has a first purely refractive subsystem, a second subsystem with precisely two concave mirrors and a third purely refractive subsystem.

In accordance with a further aspect the disclosure also concerns a projection lens of a microlithographic projection exposure apparatus for producing the image of a mask which can be positioned in an object plane on a light-sensitive layer which can be positioned in an image plane, which has
an optical axis, and
a last lens at the image plane side of intrinsically birefringent material which is selected from the group which includes magnesium oxide (MgO), garnets, in particular lutetium aluminum garnet (Lu₃Al₅O₁₂, LuAG), lithium barium fluoride (LiBaF₃) and spinel, in particular magnesium spinel (MgAl₂O₄),
wherein the last lens at the image plane side is of a thickness d which satisfies the condition 0.8*y_{0,max}<d<1.5*y_{0,max}, wherein y_{0,max} denotes the maximum distance of an object field point from the optical axis.

The disclosure further concerns a microlithographic projection exposure apparatus, a process for microlithographic production of microstructured components and a microstructured component.

In some embodiments, the present disclosure provides an optical system, such as an illumination system or a projection lens of a microlithographic exposure system, wherein an arbitrary desired polarization distribution can be effectively created with a simple structure that can be fabricated with a high precision in compliance with what is desired for microlithographic exposure systems. More particularly, the present disclosure provides an optical system wherein local disturbances of the state of polarization, in particular due the presence of one or more optical elements having a relatively high refractive index and relatively strong birefringence (e.g., due to the presence of uniaxial materials or of materials showing strong intrinsic birefringence), can be effectively compensated. As a further aspect, the present disclosure provides an optical system wherein a first (e.g., circular or linear) polarization distribution is transformed into a second (e.g., tangential) polarization distribution.

An optical system, in particular an illumination system or a projection lens of a microlithographic exposure system, according to one aspect of the present disclosure has an optical system axis and at least one element group including three birefringent elements each of which including optically uniaxial material and having an aspheric surface, wherein:
a first birefringent element of the group has a first orientation of its optical crystal axis;
a second birefringent element of the group has a second orientation of its optical crystal axis, wherein the second orientation can be described as emerging from a rotation of the first orientation, the rotation not corresponding to a rotation around the optical system axis by an angle of 90° or an integer multiple thereof, and
a third birefringent element of the group has a third orientation of its optical crystal axis, wherein the third orientation can be described as emerging from a rotation of the second orientation, the rotation not corresponding to a rotation around the optical system axis by an angle of 90° or an integer multiple thereof.

In the meaning of the present disclosure, the term “birefringent” or “birefringent element” shall include both linear birefringence and circular birefringence (i.e. optical activity, as observed, e.g., in crystalline quartz).

In some embodiments, the three birefringent elements of the element group are consecutive in such a sense that the second birefringent element is, along the optical system axis or in the light propagation direction, the next birefringent optical element following to the first element, and that the third birefringent element is, along the optical system axis or in the light propagation direction, the next birefringent optical element following to the second element. With other words, the elements of the group are arranged in the optical system in succession or in mutually adjacent relationship along the optical system axis. Furthermore, the three elements can be directly adjacent to each other without any (birefringent or non-birefringent) optical element in between.

According to some embodiments, a combination of three birefringent elements is used for achieving a desired compensation of local disturbances of the state of polarization, wherein each of the elements has an aspheric surface and thus a varying strength in its birefringent effect resulting from its thickness profile. The disclosure is involves the realization that with such a combination of three elements with suitable variations of the thickness profiles and orientations of the respective crystal axes, it is principally possible to achieve any desired distribution of the retardation, which again may be used to at least partially compensate an existing distribution of the retardation due the presence of one or more optical elements in the optical system showing strong retardation caused for instance by using uniaxial media, biaxial media, media with intrinsic birefringence or media with stress induced birefringence.

As to the theoretical considerations underlying the present disclosure, a non-absorbing (=unitary) Jones matrix having the general form

$$J = ( \begin{matrix}A & B \\ - {B}^{*} & {A}^{*}\end{matrix} ) = ( \begin{matrix}{a}_{0} + i {a}_{1} & {a}_{2} + i {a}_{3} \\ - {a}_{2} + i {a}_{3} & {a}_{0} - i {a}_{1}\end{matrix} ) \qquad ( 4 )$$

with

$${\sum }_{j = 0}^{3} {a}_{j}^{2} = 1$$

can be described by a rotation of the Poincaré-sphere, wherein points lying on the surface of the Poincaré-sphere are describing specific states of polarization. The concept of the present disclosure involves the fact that the rotation of the Poincaré-sphere can be divided into elementary rotations, which again are corresponding to specific Jones-matrices. The suitable combination of three of such Jones-matrices is used to describe a desired rotation of the Poincaré-sphere, i.e. a desired non-absorbing (=unitary) Jones matrix.

In other words, any unitary Jones matrix can be expressed as a matrix product of three matrix functions,

J=R₁(α)·R₂(β)·R₃(γ) (5)

with a suitable choice of the “Euler angles” □, □, and □.

Each of the matrix functions R₁(α), R₂(α), R₃(α) is taken from the set

$$\{ ( \begin{matrix}cos α & - sin α \\ sin α & cos α\end{matrix} ) , ( \begin{matrix}exp ( - i α ) & 0 \\ 0 & exp ( i α )\end{matrix} ) , ( \begin{matrix}cos α & - i sin α \\ - i sin α & cos α\end{matrix} ) \}$$

which describes a rotator, a retarder with 0° orientation and a retarder with 45° orientation, the strength of which are specified by □. This decomposition of any unitary Jones matrix is always possible under the condition that

R₁(α)≠R₂(α) and R₂(α)≠R₃(α) (6)

The above feature that, in the element group of three birefringent elements according to the present disclosure, the orientation of the optical crystal axis in the second (or third, respectively) birefringent element can be described as emerging from a rotation of the orientation of the optical crystal axis in the first (or second, respectively) birefringent element by an angle not corresponding to 90° or an integer multiple thereof guarantees the independency of the three birefringent elements in the above sense. This considers the fact that two elements each having an aspheric surface and such an orientation of their optical crystal axis, that the two orientations of these two elements are rotated by, e.g., an angle of 90° to each other, are in so far not independent in their polarizing effect as one of these elements can be substituted by the other if, at the same time, the sign of the respective aspheric surface (or the thickness profile) is inverted.

With other words, the element group according to the present disclosure includes three birefringent elements, wherein two subsequent birefringent elements of the optical group according to the present disclosure have different orientations of their optical crystal axis. Further, two such orientations are only regarded as being different from each other if one of these orientations cannot achieved by a rotation around the optical system axis by an angle of 90° (or an integer multiple thereof).

With still other words, the orientations of two subsequent birefringent elements of the optical group according to the present disclosure should be, in deciding whether they are really different in their polarizing effect, compared to each other “modulo 90°”. Accordingly, in a different wording the present aspect of the disclosure may be defined in that if the optical crystal axes of two subsequent birefringent elements of the optical group are lying in a plane perpendicular to the optical system axis, the “angle modulo 90°” between the two orientations of these optical crystal axes is not zero. As an example, two orientations lying in a plane perpendicular to the optical system axis with an angle of 90° to each other are regarded, according to the present disclosure, as equal or as not independent, whereas two orientations lying in a plane perpendicular to the optical system axis with an angle of 95° to each other yield an angle of “95° modulo 90°”=5° and thus are regarded as not equal or as independent from each other.

If a bundle of light rays passes such an element group of three birefringent elements whose optical crystal axes meet the above criterion, it becomes possible to compensate, for suitable selections of the aspheric surfaces or thickness profiles of these birefringent elements, any disturbance of the polarization distribution in the optical system, e.g., projection lens of a microlithography exposure system.

Generally, in order to provide at a predetermined position a predetermined phase retardation of Δφ, a thickness d is used as given by

$$d = \frac{λ Δ ϕ}{2 π Δ n} \qquad ( 7 )$$

In the context of the present disclosure a significant compensation of birefringent effects in a projection lens will typically should correspond to a retardance of at least λ·Δφ≧5 nanometers (nm). In order to provide such a compensation, the variation Δd of the thickness due to the aspheric surface corresponding to such a retardance effect will, for a typical value of Δn for, e.g., MgF₂ of 0.0024 and a typical wavelength of λ≈193 nm, amount to Δd≈5 nm/(2·π·Δn)≈331 nm. Accordingly, the lower limit for a typical quantitative level of the thickness profile variation in the aspheric surfaces can be estimated, for a wavelength of λ≈193 nm, to Δdₘᵢₙ≈0.3 μm. In terms of the achieved phase retardation Δφ, a lower limit Δφₘᵢₙ corresponding to a significant compensation of birefringent effects can be given by the criterion Δφ>(5 nm/193 nm), so that a lower limit Δφₘᵢₙ of the phase retardation can be estimated as Δφₘᵢₙ≈0.025 or Δφₘᵢₙ≈25 mrad. Therefore, according to some embodiments, each of the birefringent elements has such a variation of its thickness profile that a minimum phase retardation of Δφₘᵢₙ≈25 mrad is obtained at a given operating wavelength of the optical system.

According to some embodiments, the optical crystal axes of all of the three birefringent elements are oriented different from each other. Such an arrangement enables to realize the above concept of the three crystal orientations in configurations where the first and third birefringent element have their crystal axes oriented perpendicular to each other. This is advantageous in so far, as in case if the desired polarization effect to be compensated (i.e. to be provided by the element group) is an at least almost pure retardance (without or with only a small amount of elliptical components), the respective aspheric surfaces of the first and third element may have aspheric surfaces of substantially identical height profiles with opposite signs, leading to an at least partial compensation of the scalar effects of these surfaces.

According to some embodiments, the optical crystal axes of the first birefringent element and the third birefringent element are substantially parallel to each other. Such an arrangement favours to manufacture these two elements with identical aspheric surfaces or height profiles, which is favourable with respect to a significant simplification of the manufacturing process and the use of identical test optics for these elements.

According to certain embodiments, the optical crystal axes of all three birefringent elements are oriented perpendicular to the optical system axis, wherein the optical crystal axes of the first birefringent element and the third birefringent element are each rotated around the optical system axis with respect to the optical crystal axis of the second birefringent element of the group by an angle in the range of 30° to 60° (e.g., in the range of 40° to 50°, 45°). This is advantageous in so far as the respective elements having their optical crystal axes oriented under an angle of 45° correspond to rotations of the Poincaré-sphere around axes being perpendicular to each other, i.e. linearly independent rotations, which makes it possible to achieve a specific desired compensation effect with a more moderate height profile and smaller surface deformation.

In certain embodiments, an optical crystal axis in each of the optical elements is either substantially perpendicular or substantially parallel to the optical system axis. Here and in the following, the wording that the optical crystal axis is either “substantially perpendicular” or “substantially parallel” to the optical system axis shall express that small deviations of the exact perpendicular or parallel orientation are covered by the present disclosure, wherein a deviation is regarded as small if the angle between the optical crystal axis and the respective perpendicular or parallel orientation does not exceed ±5°.

According to some embodiments, the birefringent elements have on average essentially no refracting power. This wording is to be understood, in the meaning of the present disclosure, such that in case of an approximation of the surfaces of the respective element by a best-fitting spherical surface, the refractive power of the so approximated element is not more than 1 diopter (1 Dpt=1 m⁻¹). The property of the birefringent elements to have “on average essentially no refracting power” may be alternatively achieved by an additional compensation plate for one or more of the optical elements or may already result from the surface relief of the respective element being only marginal, i.e. being essentially similar to a plane-parallel plate. According to some embodiments, the compensation plate may include a non-birefringent material, e.g., fused silica.

According to a further aspect of the disclosure, an optical system, in particular an illumination system or a projection lens of a microlithographic exposure system, has an optical system axis and at least one element group including three element pairs each of which includes one birefringent element and one attributed compensation element, the birefringent element including optically uniaxial material and having an aspheric surface, wherein each birefringent element and the attributed compensation element supplement each other to a plane-parallel geometry of the element pair, wherein:
a first birefringent element of the group has a first orientation of its optical crystal axis;
a second birefringent element of the group has a second orientation of its optical crystal axis, wherein the second orientation can be described as emerging from a rotation of the first orientation, the rotation not corresponding to a rotation around the optical system axis by an angle of 90° or an integer multiple thereof; and
a third birefringent element of the group has a third orientation of its optical crystal axis, wherein the third orientation can be described as emerging from a rotation of the second orientation, the rotation not corresponding to a rotation around the optical system axis (OA) by an angle of 90° or an integer multiple thereof.

Accordingly, the optical system or the optical element group in this aspect are analogous to optical system or the optical element group described before and differ only in so far as the element group includes for each of the birefringent elements an attributed compensation element such that the birefringent element and the attributed compensation element add up to a plane-parallel geometry. The advantageous effect additionally achieved in this aspect is that a detrimental influence of the element group on the so-called scalar phase can be kept low and, in the ideal case, made equal to the effect caused by a plane-parallel plate on the scalar phase. The compensation element can also include an optically uniaxial material having an optical crystal axis which is oriented in the plane perpendicular to the optical system axis and oriented perpendicular to the optical crystal axis of the attributed birefringent element. As to embodiments and advantages of the optical system or the optical element group in this aspect, reference can be made to the embodiments and advantages mentioned and discussed with respect to the optical system or the optical element group according to the first aspect.

In some embodiments, the combined element or the element group is arranged in a pupil plane of the optical system.

This arrangement is advantageous in so far as light beams entering the image-sided last lens element of the projection lens under the same angle (and therefore are subjected to a birefringence of similar strength) are passing the element group or the combined element, respectively, at substantially the same position and will be identically compensated with regard to their polarization state.

In certain embodiments, the combined element or the element group is arranged at a position where the relation

$$0.8 < \frac{{D}_{1}}{{D}_{2}} < 1.0$$

is met, with D₁ being a diameter of a light bundle at the position and D₂ being a total optically used diameter at the position.

This arrangement is advantageous in view of the improved compensation which may be obtained in case of a field-dependency of the polarization effect caused by the image-sided last lens element (due to different geometrical path length within the last lens element belonging to different field positions of the light beams), since the field dependency can be better considered with a displacement of the element group or combined element respectively, with respect to the pupil plane.

In some embodiments, the optical system includes at least two combined elements or element groups, which are both arranged at a position where the relation

$$0.5 \leq \frac{{D}_{1}}{{D}_{2}} \leq 1.0$$

is met, with D₁ being a diameter of a light bundle at the respective position being a total optically used diameter at the respective position. Such an arrangement considers that the achieved compensation is particularly effective at positions being at least closed to the pupil plane. In particular, these two element groups, or combined element group, can be symmetrically arranged with regard to the pupil plane, i.e. at positions along the optical system optics having the same relation D₁/D₂, but on opposite sides on the pupil plane.

In certain embodiments, the element group or combined element, respectively, is arranged in the first pupil plane along the light propagation of the optical system. This position is advantageous particularly with respect to the enhanced possibilities to vary this pupil plane in the design in the whole optical system with regard to the corrective effect and the geometrical size of the compensation element (or element group) placed therein. This is because the first pupil plane is arranged at a position where the numerical aperture (NA) is relatively low compared to the last (i.e. image-sided) pupil plane and where the numerous optical elements being arranged downstream of this first pupil plane provide sufficient possibilities to correct and optimize the optical imaging.

In some embodiments, the combined element or the element group have a maximum axial length along the optical system axis being not more than 50% (e.g., not more than 20%, and not more than 10%) of the average optically effective diameter of the element group. Such a small axial length may be obtained by arranging the birefringent elements of the group close to each other, by making each optical element with a relatively small thickness and/or by arranging the birefringent elements (or element pairs, respectively) directly adjacent to each other without any other optical elements in between. Such a compact design of the optical element group is advantageous in so far as a divergence of light beams which are passing the same inclined to the optical system axis is reduced or minimized, so that light beams passing the element with the same distance to the optical system axis experience at least approximately the same polarization effect.

In a further aspect, the present disclosure also relates to an optical element including a first lens component embedded in a second lens component, wherein the first lens component is made from spinelle and wherein the second lens component is made from an optically isotropic material. An advantageous effect of such a structure of the optical element is that the first lens component may be made relatively thin, and any deterioration of the optical performance of the optical system due to effects of the element (in particular uniaxial or intrinsic birefringence as well as absorption) may be kept small. Such an optical element can be realized in combination with or also independent of an optical system as outlined above.

Further aspects and advantageous embodiments of the present disclosure result from the following description as well as the further appended claims whose content is made part of the description in its entirety by reference.

### BRIEF DESCRIPTION OF THE DRAWINGS

The disclosure is described in more detail with reference to the following detailed description and based upon preferred embodiments shown in the drawings, in which:

FIG. 1 shows a meridional section of a microlithography projection lens;

FIG. 2 schematically shows a principal structure of an optical element group in a side view (FIGS. 2a and 2b) and in a top view (FIGS. 2c and 2d) on each of the three elements;

FIG. 3a-c shows height profiles (in micrometres, μm) for specific birefringent elements in an element group according to FIGS. 2a-2d;

FIG. 4a-b shows the retardation of the projection lens of FIG. 1 without (FIG. 4a) and with an optical element group;

FIG. 5a-f schematically show principal structures of an optical element group according to FIG. 2a in a top view on each of the three elements;

FIG. 6 shows a meridional section of a microlithography projection lens;

FIGS. 7a-d and 8a-b show principal structures of an optical element group;

FIGS. 9a-c show height profiles for birefringence elements in the optical group according to FIGS. 7 and 8;

FIG. 10a-b show the respective retardance pupil map for the projection lens with (FIG. 10a) and without (FIG. 10b) an element group according to FIG. 7-9;

FIG. 11 shows a meridional section of a microlithography projection lens;

FIG. 12 shows a detail of the microlithography projection lens of FIG. 11;

FIG. 13a-c show height profiles (in micrometres, μm) of three optical elements in an element group that is used in order to partially compensate for the Jones-Pupil of FIG. 14a-b;

FIG. 14a-b show by way of an example a Jones-Pupil in a microlithography projection lens including a spinelle-100-lens, wherein FIG. 14a shows the distribution of the absolute value of retardation (in nm) and wherein FIG. 14b shows the direction of the fast axis;

FIG. 15a-b show the retardation profile in radiant of each of the three optical elements in an element group that is used according to the disclosure to transform a circular polarization distribution (FIG. 15a) or linear polarization distribution (FIG. 15b) into a tangential polarization distribution as a function of the azimuth angle;

FIG. 16 shows an overall meridional section through a complete catadioptric projection lens;

FIG. 17a shows a diagrammatic view on an enlarged scale of the last lens at the image plane side of the projection lens of FIG. 16;

FIGS. 17b-c show a last lens at the image plane side, which can be used in the projection lens of FIG. 16,

FIGS. 18-20 show diagrammatic views of a respective compensation element arranged in the projection lens of FIG. 16,

FIG. 21 shows a diagrammatic view of a compensation element; and

FIGS. 22a-b show the pupil distribution of the retardation for the last lens at the image plane side of the projection lens of FIG. 16 (FIG. 22a) and for the entire projection lens having regard in particular to the IBR compensation via the compensation elements (FIG. 22b).

### DETAILED DESCRIPTION

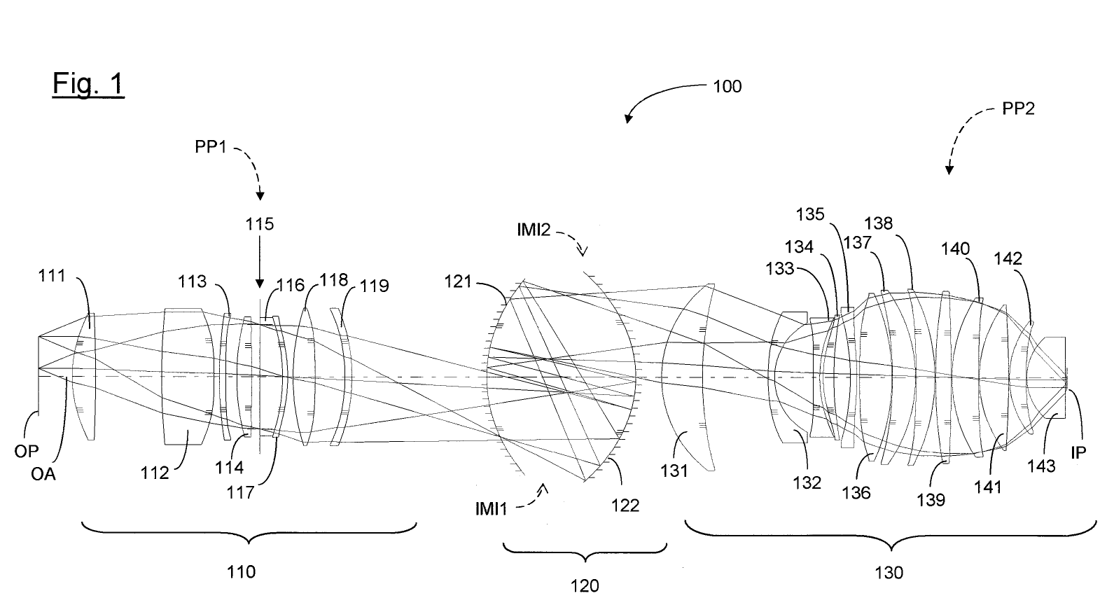

FIG. 1 shows a meridional overall section through a complete catadioptric projection lens 100. The design data of the projection lens 100 are set out in Table 1. In this Table, column 1 includes the number of the respective, reflective or otherwise distinguished optical surface, column 2 includes the radius of this surface (in mm), column 3 the distance (also named as thickness, in mm) of this surface from the next following surface, column 4 the material following to the respective surface, column 5 the refractive index of this material at λ=193 nm and column 6 the optically usable, free half diameter of the optical component (in mm).

The surfaces which are identified in FIG. 1 by short horizontal lines and which are specified in Table 2 are aspherically curved, the curvature of those surfaces being given by the following aspheric formula:

$$P ( h ) = \frac{( 1 / r ) \cdot {h}^{2}}{1 + \sqrt{1 - ( 1 + K ) {( 1 / r )}^{2} {h}^{2}}} + {C}_{1} {h}^{4} + {C}_{2} {h}^{6} + … \qquad ( 8 )$$

In that formula (8), P denotes the sagitta of the surface in question in parallel relationship with the optical axis, h denotes the radial spacing from the optical axis, r denotes the radius of curvature of the surface in question, K denotes the conical constant and C1, C2, . . . denote the aspheric constants set out in Table 2.

The projection lens 100 includes, along an optical system axis OA and between an object (or reticle) plane OP and an image (or wafer) plane IP, a first subsystem 110 including refractive lenses 111-114 and 116-119, a second subsystem 120 including a first concave mirror 121 and a second concave mirror 122 which are each cut at the appropriate positions to enable the passing of light rays there through, and a third subsystem 130 including refractive lenses 131-143. The image-sided last lens 143 of the third subsystem is a plano-convex lens made from Lu₃Al₅O₁₂ (=“LuAG”) and having a [100]-orientation, i.e. the optical system axis OA of the projection lens 100 is parallel to the [100]-crystal axis of the lens 143. The image-sided last lens 143 is adjacent to an immersion liquid being present between the last lens 143 and the light-sensitive layer on the wafer being arranged, during the operation of the projection lens 100, in the image plane IP. The immersion liquid has, in the illustrated embodiment, a refraction index of nᵢₘₘ≈1.65. A suitable immersion liquid is, e.g., “Decalin”. A further suitable immersion liquid is, e.g., Cyclohexane (nᵢₘₘ≈1.57 at λ≈193 nm).

In the sense of the present application, the term ‘subsystem’ always denotes such an arrangement of optical elements, by which a real object is imaged in a real image or intermediate image. In other words, each subsystem starting from a given object or intermediate image plane always includes all optical elements to the next real image or intermediate image.

The first subsystem 110 images the object plane OP onto a first intermediate image IMI1, the approximate position of which being marked in FIG. 1 with an arrow. This first intermediate image IMI1 is imaged, by the second subsystem 120, into a second intermediate image IMI2, the approximate position of which is also marked in FIG. 1 with an arrow. The second intermediate image IMI2 is imaged, by the third subsystem 130, into the image plane IP.

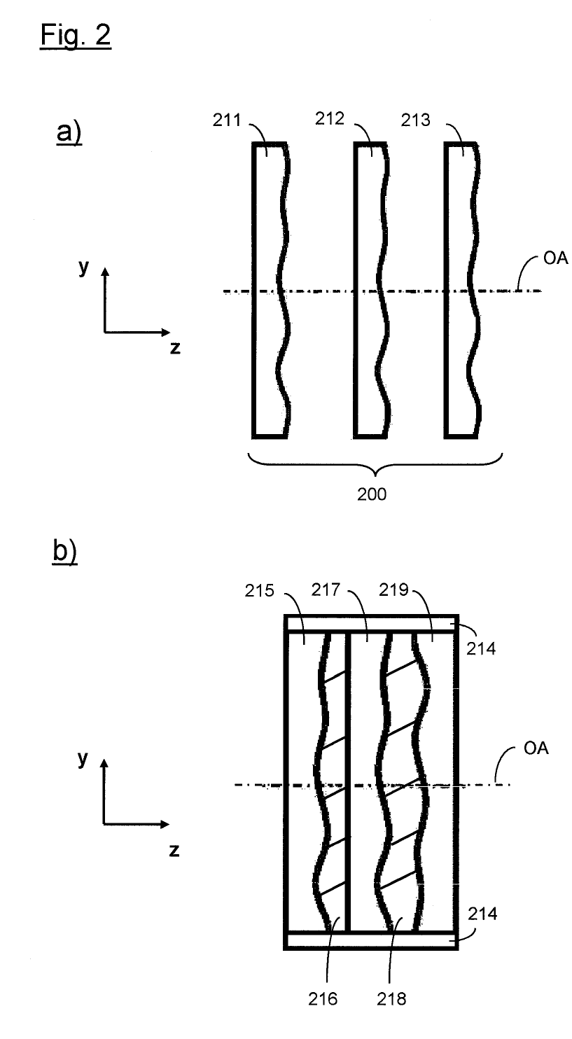

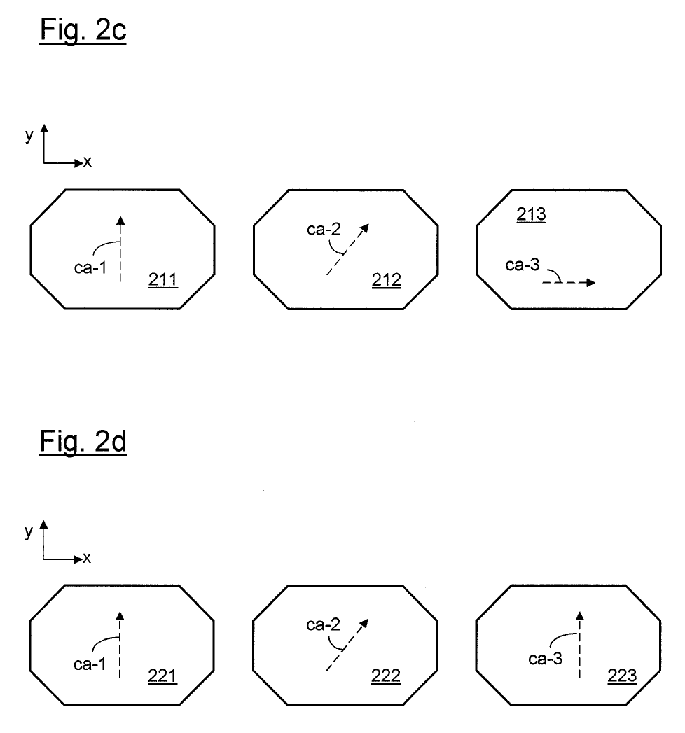

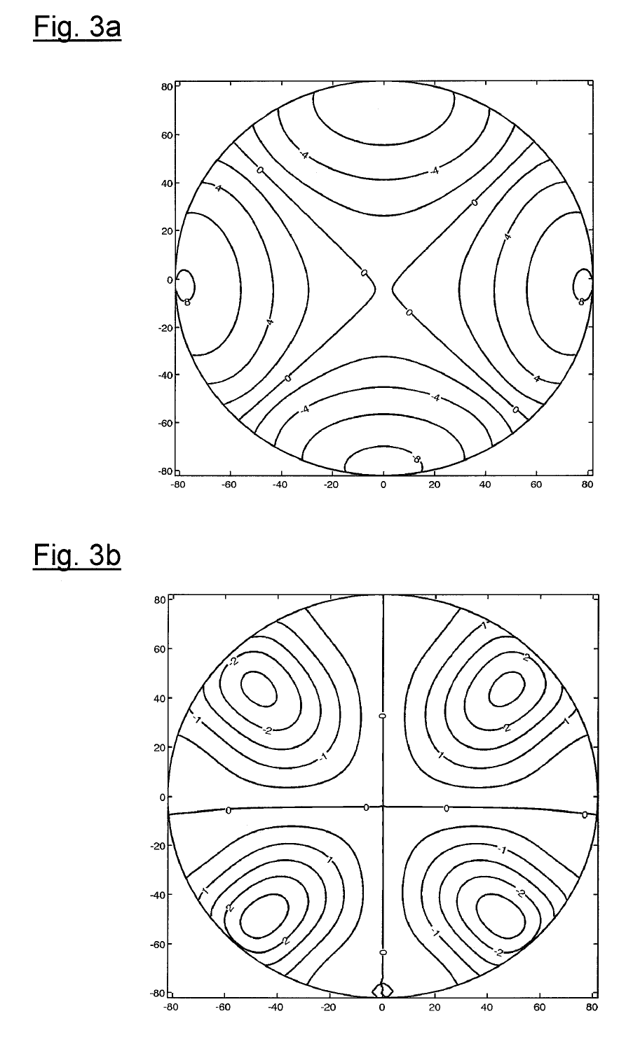

At a position marked by arrow 115 in FIG. 1 and close to the pupil plane PP1 within the first subsystem 110, an element group is provided whose structure is explained in the following with reference to FIG. 2a-d and FIG. 3.

The element group 200 has, according to FIG. 2a, three birefringent elements 211-213 each being made of optically uniaxial sapphire (Al₂O₃). The optical crystal axes of the optically uniaxial material in the three elements 211-213 are, according to FIG. 2c, oriented different from each other. Furthermore, each of the three elements 211-213 includes an aspheric surface only schematically illustrated in FIG. 2a and as explained in more detail with respect to FIG. 3. It is emphasized that the schematic illustration of FIG. 2a only serves to symbolize that each of the elements 211-213 has a varying thickness profile, while a more quantitative description of the shape of the thickness profile can be gathered from the corresponding height profiles of FIG. 3.

As to the different orientations of the optical crystal axes and more specifically, these optical crystal axes, which are named as ca-1, ca-2 and ca-3 in FIG. 2c, are all oriented in a plane perpendicular to the optical axis OA (=z-axis) of the projection lens 100, i.e. in the x-y-plane according to the coordinate system shown in FIG. 2c. Further, according to FIG. 2c, the optical crystal axis ca-1 of element 211 is oriented parallel to the y-axis, the optical crystal axis ca-2 of element 212 is clockwise rotated around the optical axis OA (i.e. the z-axis) with respect to the crystal axis ca-1 by an angle of 45°, and the optical crystal axis ca-3 of element 213 is also clockwise rotated around the optical axis OA (i.e. the z-axis) with respect to the crystal axis ca-2 by an angle of 45° (i.e. by an angle of 90° with respect to the y-axis).

More generally, the orientation of the optical crystal axis ca-2 in the second optical element 212 can be described as emerging from a rotation of the orientation of the optical crystal axis ca-1 in the first optical element 211 around the optical axis 100 of the projection lens 100, the rotation not corresponding to a rotation around the optical system axis by an angle of 90° or an integer multiple thereof. Furthermore, the orientation of the optical crystal axis ca-3 in the third optical element 213 can be described as emerging from a rotation of the orientation of the optical crystal axis ca-2 in the second optical element 212 around the optical axis OA of the projection lens 100, the rotation also not corresponding to a rotation around the optical system axis OA by an angle of 90° or an integer multiple thereof.

As to the aspheric surface provided on each of the elements 211-213, FIG. 3a shows the height profile (in micrometres, μm) of the first element 211, FIG. 3b for the second element 212 and FIG. 3c for the third element 213. It can be seen that the height profiles of the first element 211 and the third element 213 are of opposite sign and, in the illustrated example, identical in amount.

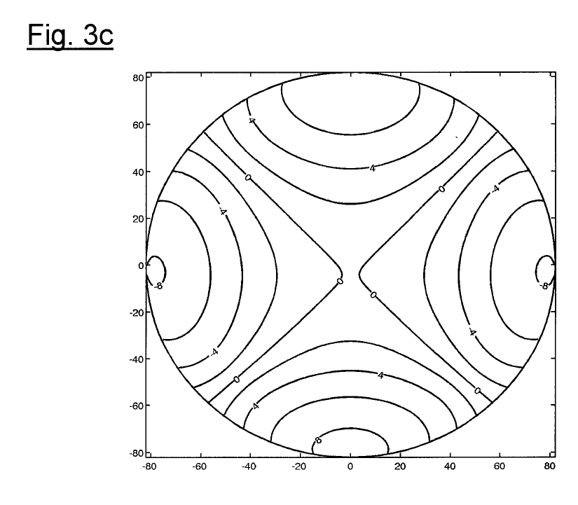

To illustrate the effect of the element group 200 in the projection lens 100, FIG. 4a shows the retardation (in nanometers, m) caused by the image-sided last lens element 143 for the case without the optical element group 200 at the position 115, while FIG. 4b shows the retardation of the projection lens 100 with the optical element group 200 at the position 115. It can be seen that the retardation in FIG. 4a has maximum values of approximately 180 nm, whereas the maximum retardation in FIG. 4b is significantly reduced to very low values of approximately 0.5 nm, which is more than sufficient for typical lithography applications.

FIG. 2d shows a further example of an element group of elements 221-223, wherein the orientations of the optical crystal axes ca-1 and ca-3 in the first element 221 and the third element 223 are identical and differ from the orientation of the optical crystal axis ca-2 in the second element 222. More specifically and as illustrated in FIG. 2d, the optical crystal axes ca-1 and ca-3 of elements 221 and 223 are both oriented parallel to the y-axis, whereas the optical crystal axis ca-2 of element 212 is rotated around the optical axis OA (i.e. the z-axis) with respect to the crystal axis ca-1 by an angle of 45°.

As a common feature with the embodiment of FIG. 2c, the orientation of the optical crystal axis ca-2 in the second optical element 222 can be described as emerging from a rotation of the orientation ca-1 of the optical crystal axis ca-1 in the first optical element 221 around the optical axis OA of the projection lens 100, the rotation not corresponding to a rotation around the optical system axis by an angle of 90° or an integer multiple thereof. Furthermore, the orientation of the optical crystal axis ca-3 in the third optical element 223 can be described as emerging from a rotation of the orientation of the optical crystal axis ca-2 in the second optical element 222 around the optical axis OA of the projection lens 100, the rotation also not corresponding to a rotation around the optical system axis by an angle of 90° or an integer multiple thereof.

As to the aspheric surface provided on each of the elements 221-223, FIG. 3a shows the height profile (in micrometres, μm) of the first element 221 and the third element 223, whereas FIG. 3b shows the height profile for the second element 222. Accordingly, in this specific example the height profiles of the first element 221 and the third element 223 are identical, which means that this element is suitable to compensate, in the projection lens 100, a retardation without elliptical components. However, the disclosure is not limited thereto, so the disclosure also includes groups of optical elements 221-222c with the principal structure of FIG. 2c, but with different height profiles of the first and third element 221 and 223.

Although the elements 211-213 and 221-223 of the embodiments described with reference to FIG. 2-3 are all made from sapphire (Al₂O₃), the disclosure is not limited to this, and other optically uniaxial materials having sufficient transparency in the used wavelength region, for example but not limited to magnesium-fluoride (MgF₂), lanthanum-fluoride (LaF₃) and crystalline quartz (SiO₂) can be alternatively used. Furthermore, the disclosure is not restricted to a realization of all the three elements 211-213 or 221-223 from the same material, so that also different combinations of materials may be used.

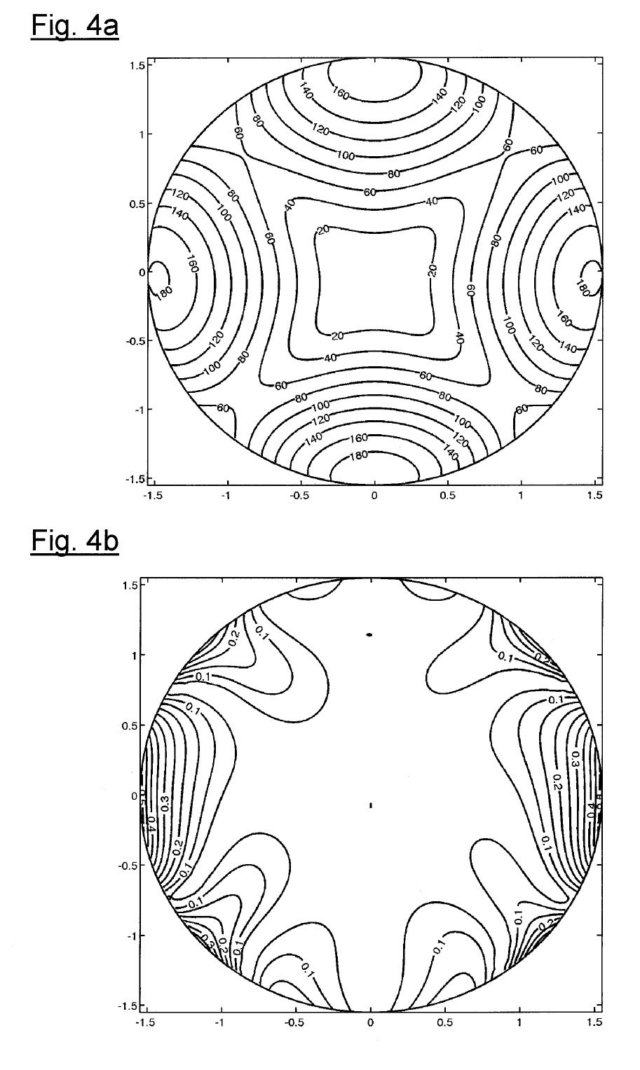

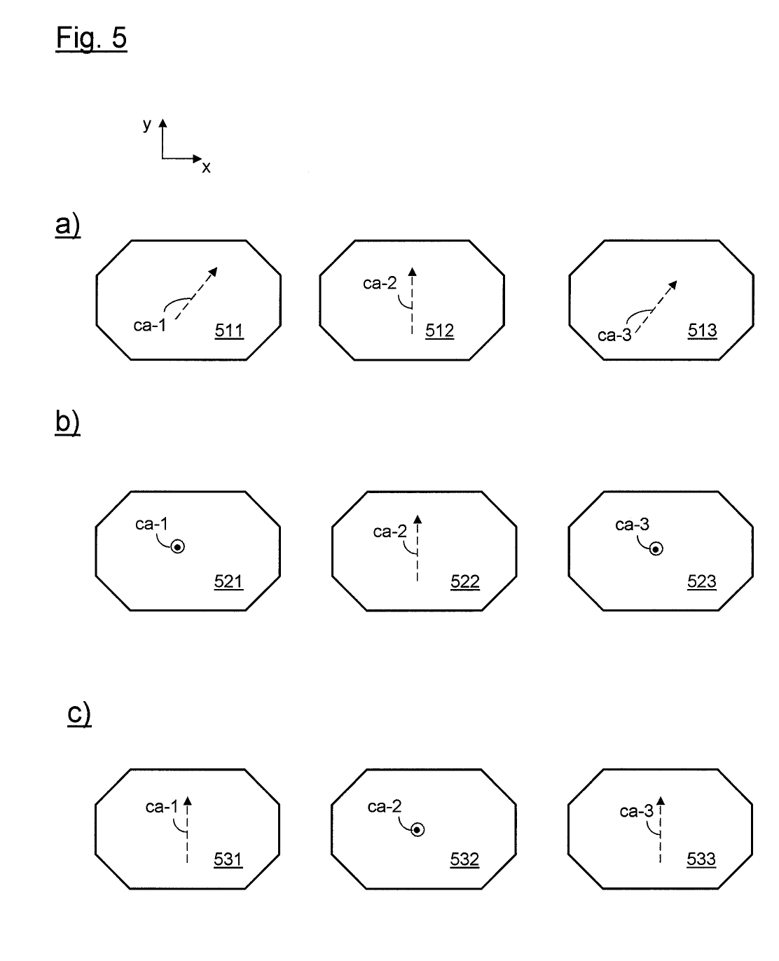

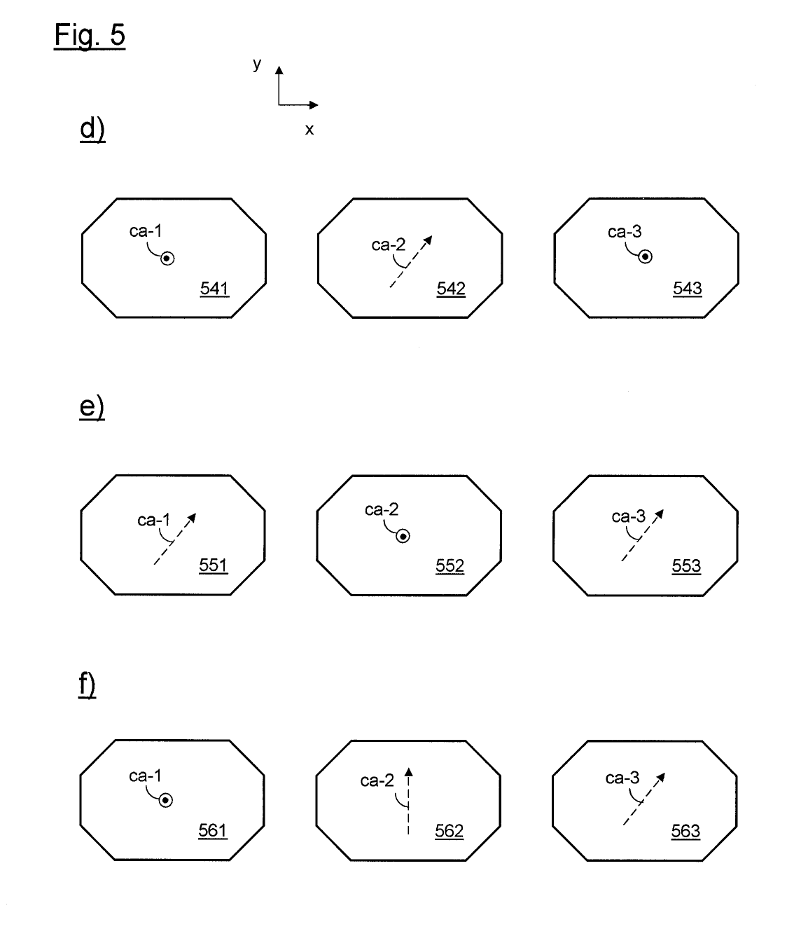

FIG. 5a-f show principal structures of an optical element group according to FIG. 2a in a top view on each of the three elements.

To generalize these different embodiments of element groups according to FIG. 5 and like in FIG. 2c and FIG. 2d, for any of these element groups, the orientation of the optical crystal axis ca-2 in the respective second optical element 512-562 can be described as emerging from a rotation of the orientation ca-1 of the optical crystal axis ca-1 in the respective first optical element 511-561 around the optical axis 100 of the projection lens 100, the rotation not corresponding to a rotation around the optical system axis by an angle of 90° or an integer multiple thereof. Furthermore, the orientation of the optical crystal axis ca-3 in the respective third optical element 513-563 can be described as emerging from a rotation of the orientation of the optical crystal axis ca-2 in the respective second optical element 512-563 around the optical axis OA of the projection lens 100, the rotation also not corresponding to a rotation around the optical system axis by an angle of 90° or an integer multiple thereof.

As a further common feature of these elements groups and like in FIG. 2c and FIG. 2d, the optical crystal axes “ca-1” and “ca-3” of two of the respective three elements (e.g., element 511 and element 513 in FIG. 5a) are oriented differently from the optical crystal axis of the third element (e.g., element 512 in FIG. 5a).

More specifically according to FIG. 5a, the optical crystal axis “ca-2” of element 512 is running into the y-direction in the coordinate system illustrated in the figure, while the optical crystal axes ca-1 and ca-3 are both rotated around the optical system axis OA and with respect to the optical crystal axis ca-2 by 45°. All elements 511-513 may, e.g., be made from magnesium-fluoride (MgF₂), sapphire (Al₂O₃) or another suitable optically uniaxial material.

According to FIG. 5b, the optical crystal axis ca-2 of element 522 is running into the y-direction in the coordinate system illustrated in the figure, while the optical crystal axes ca-1 and ca-3 of elements 521 and 523 are running parallel to the optical system axis OA (i.e. into z-direction). Element 522 is, e.g., made from magnesium-fluoride (MgF₂), while elements 521 and 523 are made from optically active quartz.

According to FIG. 5c, the optical crystal axis ca-2 of element 532 is running parallel to the optical system axis OA (i.e. into z-direction), while the optical crystal axes ca-1 and ca-3 of elements 531 and 533 are running into the y-direction in the coordinate system illustrated in the figure. Elements 531 and 533 are, e.g., made from magnesium-fluoride (MgF₂), while element 532 is made from optically active quartz. According to FIG. 5d, the optical crystal axis ca-2 of element 542 is running perpendicular to the optical system axis OA and is rotated with respect to the y-direction by 45°, while the optical crystal axes ca-1 and ca-3 of elements 541 and 543 are running parallel to the optical system axis OA (i.e. the z-direction in the coordinate system illustrated in the figure). Element 542 is, e.g., made from magnesium-fluoride (MgF₂), while elements 541 and 543 are made from optically active quartz.

According to FIG. 5e, the optical crystal axis ca-2 of element 552 is running parallel to the optical system axis OA (i.e. the z-direction in the coordinate system illustrated in the figure), while the optical crystal axes ca-1 and ca-3 of elements 551 and 553 are running perpendicular to the optical system axis OA and are rotated with respect to the y-direction by 45°. Elements 541 and 543 are made from magnesium-fluoride (MgF₂), while element 542 is made from optically active quartz.

According to FIG. 5f, the optical crystal axis ca-1 of element 561 is running parallel to the optical system axis “OA” (i.e. into z-direction). The optical crystal axis ca-2 of element 562 is running into the y-direction. The optical crystal axis ca-3 of element 563 is running perpendicular to the optical system axis OA and is rotated with respect to the y-direction by 45°. Elements 562 and 563 are, e.g., made from magnesium-fluoride (MgF₂), while element 561 is made from optically active quartz. Accordingly, in FIG. 5f, the optical crystal axes of all of the three optical elements 561-563 are, like in FIG. 2c, oriented different from each other. Of course, in FIG. 5f is not limited to the illustrated order of elements 561-563 but includes all possible permutations of these elements (with, e.g., element 563 being arranged between elements 561 and 562 etc.).

As a further common feature of the above described element groups, each of them includes three optical elements being made of an optically uniaxial material and having a varying thickness profile along the optical system axis, wherein an optical crystal axis in each of the optical elements is either substantially perpendicular or substantially parallel to the optical system axis, and wherein the optical crystal axes of at least two of the three optical elements are oriented different from each other.

In FIGS. 2d and 5a, all of the three optical elements have an optical crystal axis which is substantially perpendicular to the optical system axis, wherein the optical crystal axes of a first optical element and a second optical element (namely elements 211 and 213 or 511 and 513, respectively) of the group are substantially parallel to each other and rotated around the optical system axis with respect to the optical axis of a third optical element (namely elements 212 or 512, respectively) of the group.

In FIG. 5b-f, only one or two of the optical elements (namely elements 522, 531, 533, 542, 551, 553) of the group have an optical crystal axis which is substantially perpendicular to the optical system axis, wherein the other optical element(s) (namely elements 521, 523, 532, 541, 543, 552, 561) of the group have an optical crystal axis which is substantially parallel to the optical system axis. In these embodiments, the elements having an optical crystal axis which is substantially parallel to the optical system axis OA are made from an optically active material, e.g., quartz.

In FIG. 5f, the optical crystal axes of all of the three optical elements 561-563 are oriented different from each other. The element having an optical crystal axis which is substantially parallel to the optical system axis OA is made from an optically active material, e.g., crystalline quartz.

FIG. 2b shows an element group, which has the advantageous effect that a detrimental influence of the element group on the so-called scalar phase can be kept low. According to the concept schematically illustrated in FIG. 2b, intermediate spaces 216, 218 between different birefringent elements 215, 217 and 219 are filled with a liquid in order to reduce the shift in refractive index occurring when the light passing the optical group enters a light entrance surface or leaves a light exit surface of any of the birefringent elements. In FIG. 2b, each of the birefringent elements 215, 217 and 219 is made of MgF₂, and the intermediate spaces 216 and 218 are filled with water (H₂O).

At a typical operating wavelength of λ≈193.38 nm, the ordinary refractive index of MgF₂ is nₒ≈1.4274, and the extraordinary refractive index is nₑ≈1.4410, corresponding to an average refractive index n̅=(nₒ+nₑ)/2≈1.4342. The refractive index of water (H₂O) at λ≈193.38 nm is 1.4366. Accordingly, the shift in refractive index occurring between the birefringent elements 215, 217 and 219 and the intermediate spaces 216 and 218 amounts (for the averaged index in MgF₂) to Δn≈0.0024. For comparison, the shift in refractive index, if the intermediate spaces 216 and 218 are filled with a typical filling gas as, e.g., nitrogen (N₂) at λ≈193.38 nm, is Δn≈0.439. Accordingly, the shift in refractive index occurring between the birefringent elements 215, 217 and 219 and the intermediate spaces 216 and 218 is reduced, for FIG. 2b, approximately by a factor of 180.

Of course, the above concept of filling the intermediate spaces between the birefringent element with a suitable liquid in order to reduce the shift in refractive index occurring at light entrance surfaces and/or light exit surfaces of the birefringent elements is not limited to the above combination of MgF₂ with H₂O. In general, a liquid may be regarded as suitable to significantly improve the above index-shift-situation between the birefringent elements of the inventive element group, and thus reduce a detrimental influence of the element group on the so-called scalar phase, if a gap between at least two of the birefringent elements is at least partially filled with a liquid having a refraction index that differs not more that 30% (e.g., not more than 20%, not more than 10%) of the refraction indices of the two birefringent elements. Depending on the refractive indices of the material in the adjacent birefringent elements, such suitable liquids may also be so-called high-index immersion liquids which are also used as immersion liquids in the region between the image-sided last lens and the light-sensitive layer being present on the wafer, such as, e.g., “Decalin” (nᵢₘₘ≈1.65 at λ≈193 nm) or Cyclohexane (nᵢₘₘ≈1.57 at λ≈193 nm).

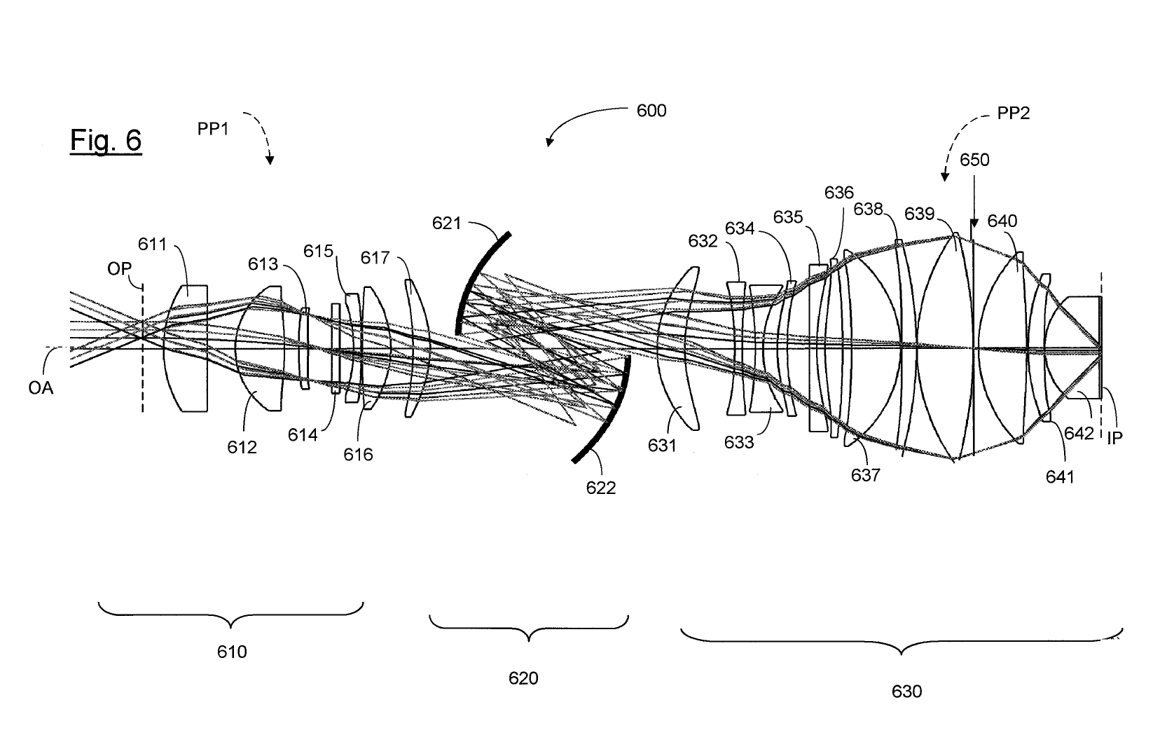

FIG. 6 shows a meridional overall section through a complete catadioptric projection lens 600. The design data of the projection lens 600 are set out in Table 3, with the surfaces specified in Table 4 are aspherically curved.

The projection lens 600 has a similar, catadioptric design as the projection lens 100 of FIG. 1 and includes along the optical axis OA a first subsystem 610 with lenses 611-617, a second subsystem 620 with two mirrors 621 and 622 and a third subsystem 630 with lenses 631-642.

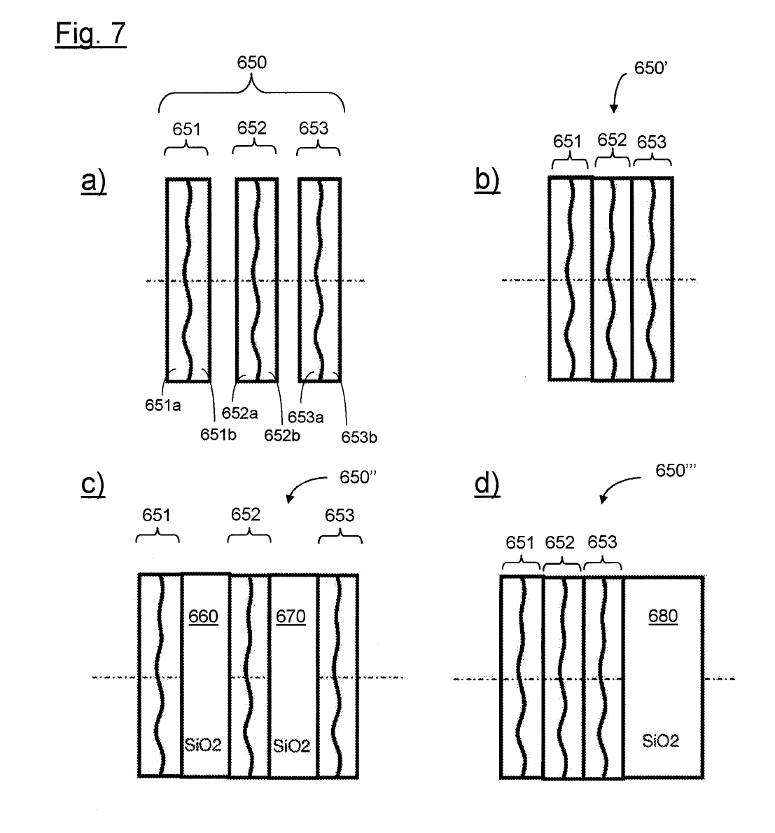

The projection lens 600 also includes, at a position marked with an arrow and closed to the pupil plane PP2 within the third subsystem 630, an element group 650, certain embodiments of which being described in the following with reference to FIGS. 7 and 8. The advantageous effect achieved by these embodiments is that a detrimental influence of the element group on the so-called scalar phase can be kept low and, in the ideal case, made equal to the effect caused by a plane-parallel plate on the scalar phase.

To this, the element group 650 as schematically illustrated in FIG. 6a includes three birefringent elements 651, 652 and 653, each of which being composed of two plates 651a and 651b, 652a and 652b, or 653a and 653b, respectively. Each of the respective plates being attributed to each other has an aspheric surface and a plane surface, wherein the aspheric surfaces of the plates being attributed to each other are complementary and add up to a plane-parallel geometry of the such-formed birefringent element 651, 652 or 653, respectively. With other words, the thickness of each formed birefringent element 651, 652 or 653, respectively, is constant over its cross-section.

Furthermore, as can be seen in FIG. 8a which is showing all six plates 651a-653b in an exploded way of illustration just for a better representation of the optical crystal axes, the optical crystal axes of the respective plates 651a and 651b, 652a and 652b, or 653a and 653b, respectively being attributed to each other are oriented perpendicular to each other. Apart from the orientation of the optical crystal axes, the plates of each pair 651a and 651b, 652a and 652b, or 653a and 653b, respectively, and all six plates 651a-653b can be made of the same optically uniaxial material, e.g., Al₂O₃, MgF₂ or LaF₃.

As a consequence of the plane-parallel geometry of the birefringent elements 651-653, each of the birefringent elements 651, 652 and 653 does not disturb or affect the scalar phase of light passing though the element group 650, since the aspheric boundaries which are present within each birefringent element 651, 652 and 653 at the position where the two plates complementary abut on each other with their aspheric surface are only boundaries between regions of identical refractive indices. FIG. 8a is just exemplarily, and further embodiments to realize the general concept of FIG. 7 can be constructed by composing an element group as follows: As to the respective first plates 651a, 652a and 653a of each birefringent element 651, 652 and 653, these plates are arranged according the optical axis OA according to the principal structure of FIG. 5a. Similarly, the other embodiments described above and illustrated in FIG. 2c-d and FIG. 5b-f may be modified by replacing, in each of the embodiments, at least one (and desirably all) of those birefringent elements which have their optical crystal axis oriented in a plane perpendicular to the optical system axis OA by a pair of plates as described before with reference to FIG. 7-8, i.e. by plates being pairwise complementary to each and adding up to a plan-parallel geometry of the such-formed birefringent element and having optical crystal axes being oriented pairwise perpendicular to each other.

Although the three birefringent elements 651-653 of FIG. 7a of the optical group 650 are shown separated from each other, they may be, as shown in FIG. 7b, joined together to form a common optical element 650′, which is favourable in view of the mechanical stability of the arrangement taking into consideration the relatively low thickness of the plates 651a-653b, which is typically much less than 1 mm and may, e.g., be in the range of several micrometers.

In some embodiments, one or more support plates of a significantly larger thickness are used as schematically illustrated in FIGS. 7c and 7d. More specifically, FIG. 7c shows two such support plates 660 and 670, one of each being arranged between each neighboured birefringent elements 651 and 652 or 652 and 653, respectively, to form a common element 650″. FIG. 7d shows all three birefringent elements 651-653 joined together as already shown in FIG. 7b and supported by a single support plate 680 to form a common element 650′″. A perspective view of this embodiment is shown in FIG. 8b. Such one or more support plates 660, 670 and 680 can be made from an optically isotropic material such as fused silica (SiO₂). Although the thicknesses of such support plates are principally arbitrary, typical thicknesses are in the range of several millimetres.

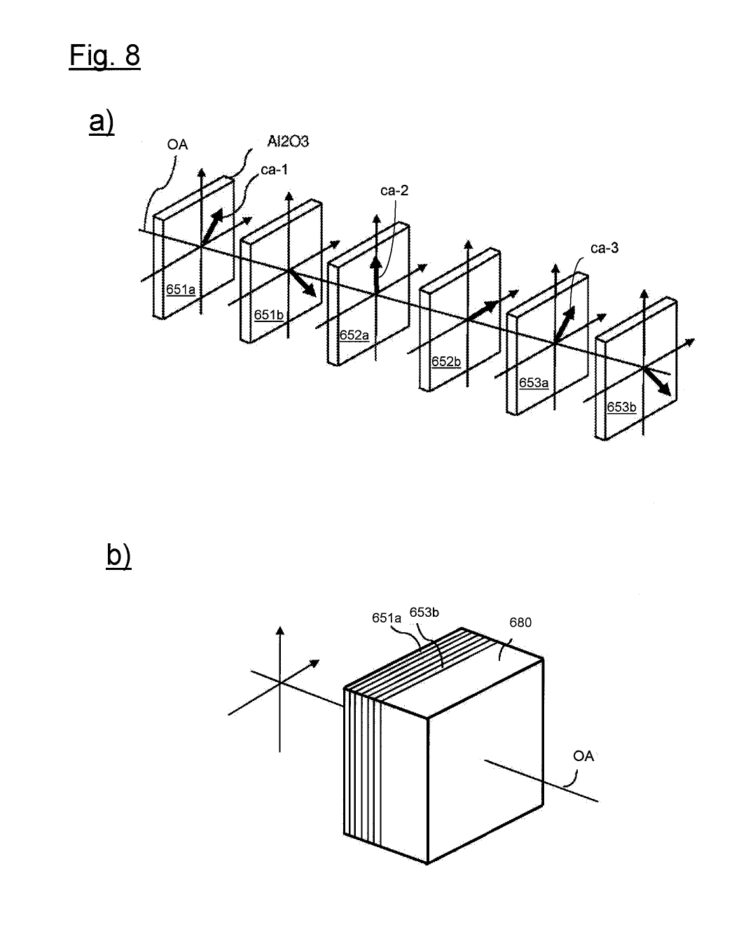

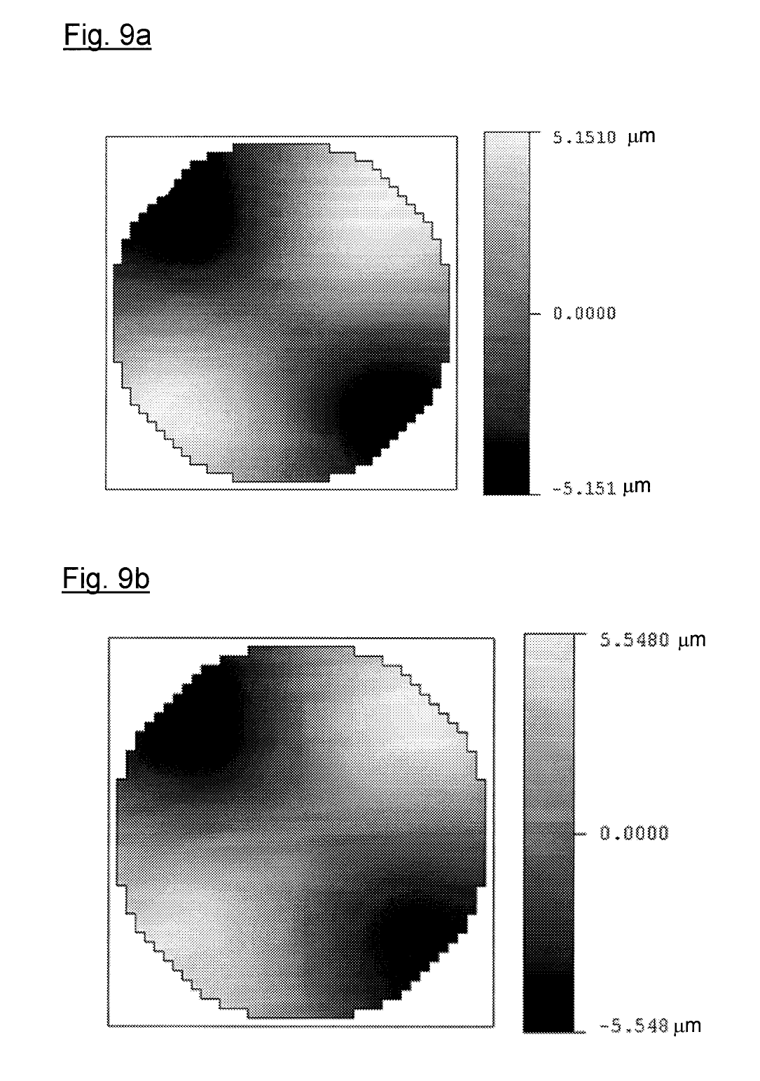

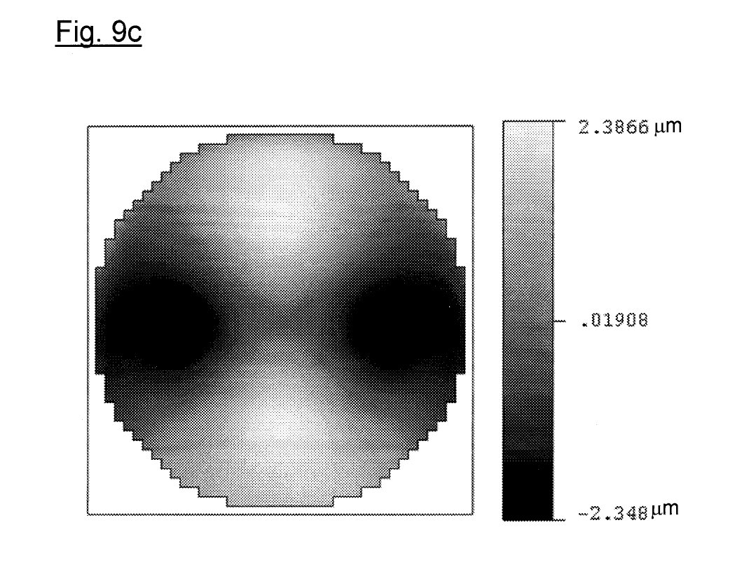

The height profiles of the birefringent elements according to FIG. 8 are shown in FIG. 9. A quantitative description of the height profiles of the birefringent elements can be given, e.g., based on the commercially available software “CODE V 9.6” (October 2005) of “OPTICAL RESEARCH ASSOCIATES”, Pasadena, Calif. (USA), according to which the respective free-form surfaces, as described in the corresponding Release Notes of this software, are described via a polynomial approximation using the equation

$$z = \frac{c \cdot {r}^{2}}{1 + \sqrt{[ 1 - ( 1 + k ) \cdot {c}^{2} \cdot {r}^{2} ]}} + {\sum }_{j} {C}_{j + 1} \cdot {Z}_{j} , \qquad ( 9 )$$

wherein z denotes the sagitta of the surface parallel to the z-axis, c denotes the vertex curvature, k denotes the conical constant, Zⱼ denotes the j^{th} Zernike polynomial (standard Zernike polynomials in radial coordinates, i.e. Z₁=1, Z₂=R·cos θ, Z₃=R·sin θ, Z4=R²·cos 2θ, etc.) and Cⱼ₊₁ denotes the coefficient for Zⱼ.

For FIGS. 9a-9c, Table 5 gives for each of the free-form surfaces 41, 43 and 45 the corresponding coefficients of the above Zernike polynomials, wherein ZP₁=C₂ denotes the coefficient of term 1-zernike-polynomial, ZP₂=C₃ denotes the coefficient of term 2-zernike-polynomial, . . . , ZP₆₃=C₆₄ denotes the coefficient of term 63-zernike-polynomial etc.

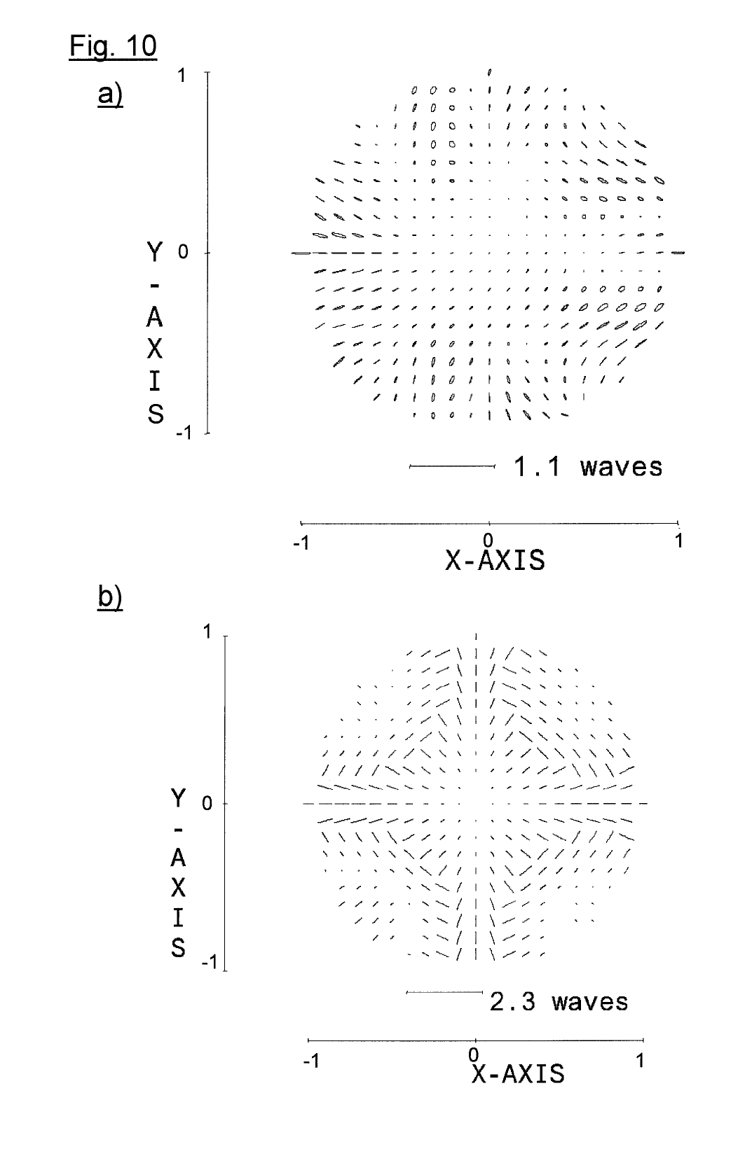

The effect of the corresponding optical group is shown in FIGS. 10a-10b by way of the respective retardance pupil map for the projection lens with (FIG. 10a) and without (FIG. 10b) an element group according to FIG. 7-9. It can be seen that the element group effects a significant reduction of the retardance (note the different scales in FIGS. 10a and 10b).

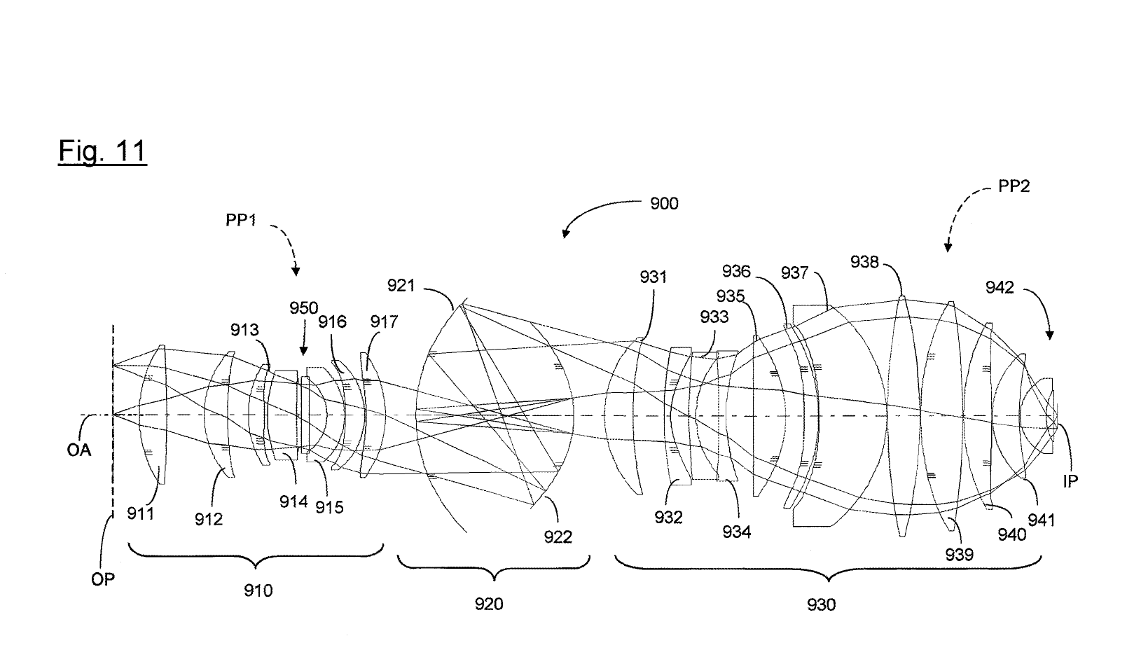

FIG. 11 shows a meridional overall section through a complete catadioptric projection lens 900. The projection lens 900 has a similar design as the projection lens 100 of FIG. 1, and includes along the optical axis OA a first subsystem 910 with lenses 911-917, a second subsystem 920 with two mirrors 921 and 922 and a third subsystem 930 with lenses 931-942.

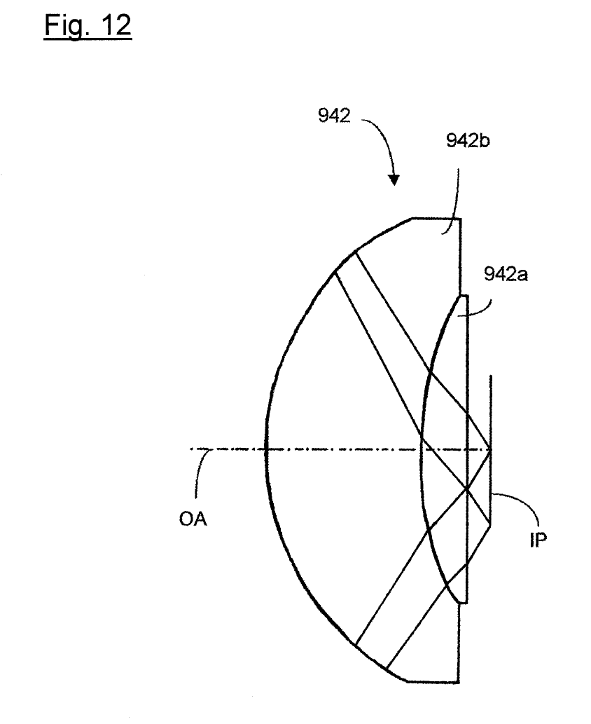

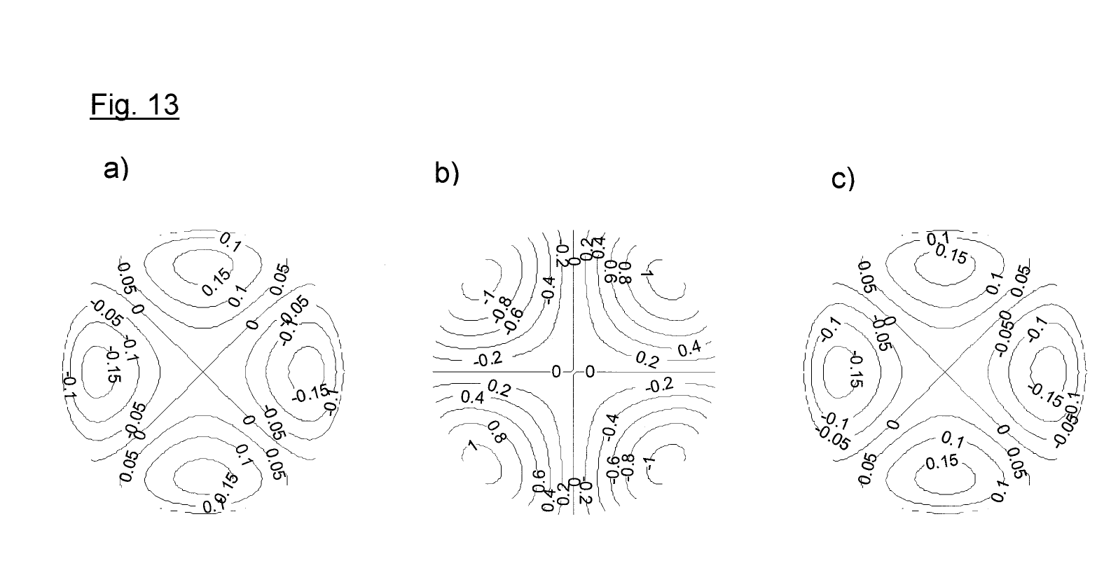

In order to compensate for a disturbance of the polarization within the projection lens 900, the projection lens 900 again includes, in the first pupil plane “PP1” and at a position marked with arrow, a correction element 950 formed of an element group of three birefringent elements as has been described above, with the height profiles of three optical elements being discussed below with reference to FIGS. 13a-13c.

As a further aspect of the projection lens 900 of FIG. 11, the last lens 942 of the third partial system 930 (i.e. the lens closest to the image plane IP) includes a first lens component 942a embedded in a second lens component 942b as described below in more detail with reference to the enlarged schematic diagram of FIG. 12.

It is to be noted that the realization of this “embedded lens”-configuration is of course not limited to a combination with the compensation concept of making use, for compensation of a disturbance of polarization, of an optical group or correction element composed of at least three birefringent elements with aspheric surfaces. Accordingly, the aspect illustrated in FIG. 12 also covers other designs (without such correction element or optical group) where an optical lens, which may particularly be an image-sided last element, i.e. an optical element being most close to the image plane, is realized by embedding a first lens component in a second lens component, as described in the following.

Generally, the arrangement shown in FIGS. 11 and 12 is advantageous if the first lens component 942a is made from an optically uniaxial material or a material of cubic crystal structure with strong intrinsic birefringence, and the second lens component 942b is made from an optically isotropic material. Beside a cubic crystal like spinelle, the material of the first lens component can, e.g., be selected from magnesium-fluoride (MgF₂), lanthanum-fluoride (LaF₃), sapphire (Al₂O₃) and crystalline quartz (SiO₂). An advantageous effect of the above structure of the optical element is that the first lens component 942a may be made relatively thin, and any deterioration of the optical performance of the optical system due to effects of the element (in particular uniaxial or intrinsic birefringence as well as absorption) may be kept small.

In the exemplarily embodiment of the image-sided last lens 942 of FIGS. 11 and 12, the first lens component 942a is made from (100)-spinelle, and the second lens component 942b is made from fused silica (SiO₂). In the specific example of FIGS. 11 and 12, the lens 942 is described by the following parameters of Table 6:

TABLE 6

| | | |
|---|---|---|
| Image field size | Lₘₐₓ | 26 mm |
| Numerical Aperture | NA | 1.5 |
| Refraction index | n_{Immersion} | 1.7 |
| (Immersion) | | |
| Working distance | S | 3 mm |
| Lens thickness | H | 12 mm |
| Max. propagation angle | ${ϑ}_{max} = arcsin \frac{NA}{{n}_{Immersion}}$ | 62° |
| Lens diameter | D = Lₘₐₓ + 2s tan [symbol] ₘₐₓ | 40 mm |

Furthermore, the arrangement of FIG. 12 can be realized by a close contact between the light entrance surface of the first lens component 942a and the light exit surface of the second lens component 942b. Alternatively, an immersion liquid layer or a small air-gap may be arranged between the light entrance surface of the first lens component 942a and the light exit surface of the second lens component 942b.

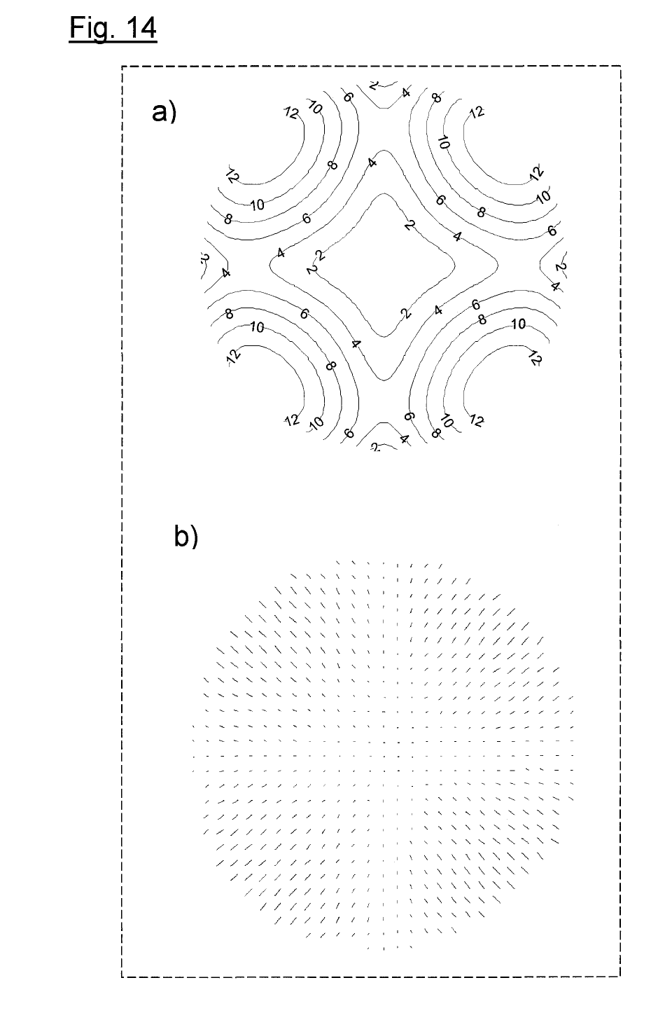

Referring again to the correction element 950 mentioned above, the correction element is used in the projection lens 900 for compensating the Jones-Pupil illustrated in FIG. 14a-b, wherein the Jones-Pupil has been determined for a microlithography projection lens including a spinelle-100-lens. More specifically, FIG. 14a shows the distribution of the absolute value of retardation (in nm) and FIG. 14b shows the direction of the fast axis of retardation.

FIG. 13a-c show the height profiles of the first, second and third optical element, respectively, being arranged according to the general structure of FIG. 2a. In the illustrated embodiment, each of the optical elements 951-953 is made of magnesium-fluoride. These height profiles are determined by first determining, for each of the first, second and third optical element, the retardation distribution desired to achieve the desired compensation effect, and then calculating the corresponding height profile. Generally, in order to provide at a predetermined position a predetermined retardation of Δφ, a thickness d is used as given in the (already above-mentioned) equation (7).

$$d = \frac{λ Δ ϕ}{2 π Δ n} \qquad ( 7 )$$

As to the general shape of the Jones-Pupil illustrated in FIG. 14, the distribution of retardation shown in FIG. 14a has a fourfold symmetry as it is characteristic for the spinelle-[100]-lens to be compensated for in the exemplarily embodiment. Furthermore, it can be seen that for each of the first, second and third optical element, the height profile has a mirror symmetry with two axes as well as a sign-change with rotation by an angle of 90°.

According to a further aspect of the disclosure, a group of optical elements as outlined above with reference to FIG. 1-12 may be used to generally transform a first (e.g., circular or linear) polarization distribution into a second (e.g., tangential) polarization distribution. To this, reference can be made, e.g., to the general configuration of FIG. 2d, i.e. with the optical crystal axes of all birefringent, elements 211-213 being perpendicular to the optical system axis, and with the optical crystal axis of the second element ca-2 being rotated around the optical system axis OA and with respect to the optical crystal axes ca-1 and ca-3 of the first and the second optical element by 45°. All three elements are again made of optically uniaxial material and may, e.g., be made of magnesium-fluoride (MgF₂).

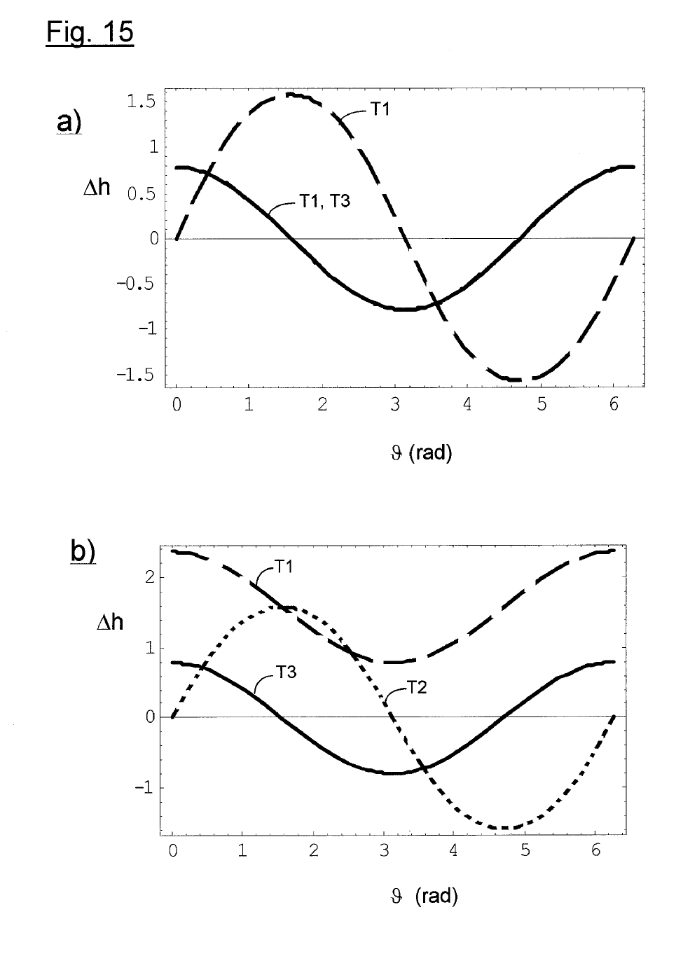

If the three birefringent elements of such a group have the retardation profiles illustrated in FIG. 15a, this element group may be used to transform a circular polarization distribution into a tangential polarization distribution. In FIGS. 15a and 15b, curve “T1” illustrates the retardation profile a function of the azimuth angle θ for the first element 201, curve “T2” illustrates the retardation profile for the second element 202 and curve “T3” illustrates the retardation profile for the third element 203. The respective retardation profiles may be constant in the radial direction. If the three elements of the element group show the retardation profiles illustrated in FIG. 15b, this element group may be used to transform a linear polarization distribution into a tangential polarization distribution.

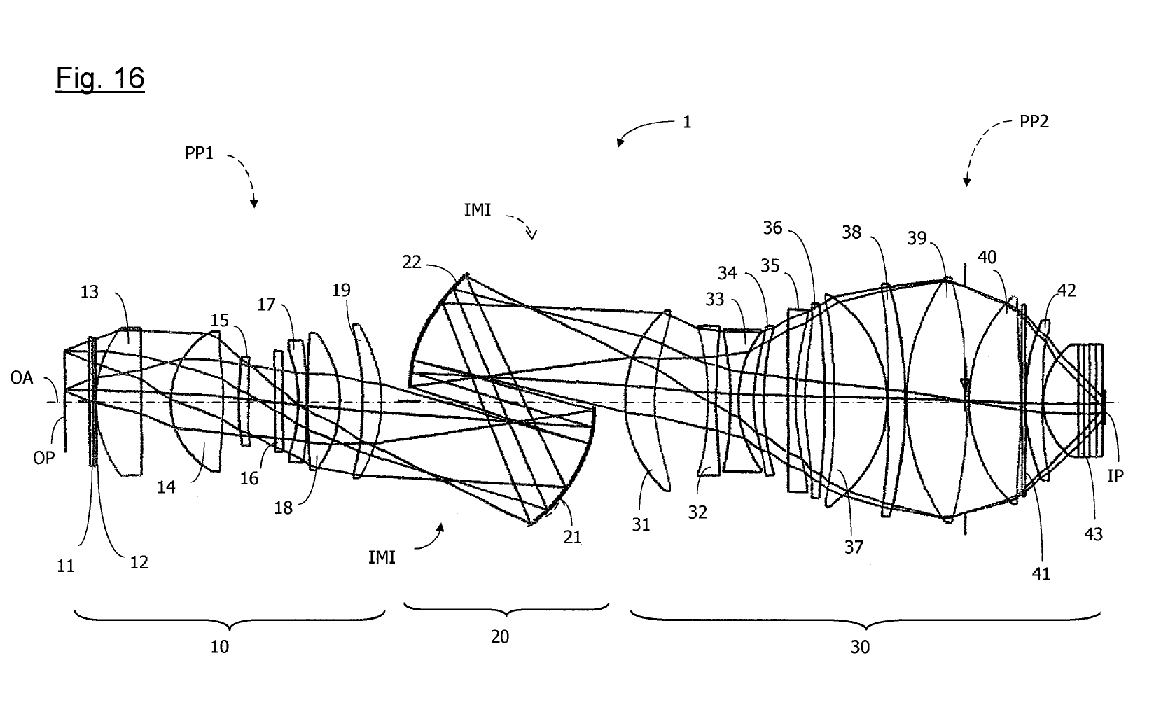

Referring to FIG. 16 shown therein is a projection lens 1. The design data of that projection lens 1 are set out in Table 7. In that respect the number of the respective refractive or otherwise significant optical surface is identified in column 1, the radius r of that surface is identified in column 2, the thickness (also referred to as spacing) of that surface in relation to the following surface is identified in column 3, optionally a reference to a reflecting nature of the surface is identified in column 4, the material following the respective surface is identified in column 5, the refractive index of that material at λ=193 nm is identified in column 6 and the optically usable free semidiameter of the optical component is identified in column 7. Radii, thicknesses and semidiameters are specified in millimeters. The projection lens 1 has a numerical aperture of NA=1.55, a rectangular image field of dimensions 26*5.5 mm, a track length (=length of the projection lens from the object plane to the image plane) of 1290 mm and a maximum lens diameter of 305 mm.

The surfaces specified in Table 8 are aspherically curved, wherein the curvature of those surfaces is given by the afore mentioned aspheric formula (8).

As shown in FIG. 16 the projection lens 1 in a catadioptric overall structure has a first optical subsystem 10, a second optical subsystem 20 and a third optical subsystem 30. Again, the term ‘subsystem’ is used to denote such an arrangement of optical elements, by which a real object is imaged into a real image or intermediate image. In other words any subsystem, starting from a given object or intermediate image plane, always includes all optical elements as far as the next real image or intermediate image.

The first optical subsystem 10 includes in particular an arrangement of refractive lenses 13-19 and produces the image of the object plane ‘OP’ as a first intermediate image IMI1, the approximate position of which is indicated by an arrow. That first intermediate image IMI1 is imaged by the second optical subsystem 20 into a second intermediate image IMI2, the approximate position of which is also indicated by an arrow. The second optical subsystem 20 includes a first concave mirror 21 and a second concave mirror 22 which are respectively cut off in a direction perpendicular to the optical axis OA so that light propagation can respectively occur from the reflecting surfaces of the concave mirrors 21, 22, towards the image plane ‘IP’. The second intermediate image IMI2 is imaged by the third optical subsystem 30 into the image plane IP.

The third optical subsystem 30 includes an arrangement of refractive lenses 31-40 and 42-43. Disposed between the light exit surface of the last lens 43 at the image plane side and the light-sensitive layer arranged in the image plane IP in operation of the projection lens 1 is an immersion liquid which in the embodiment has a refractive index of 1.65 at a working wavelength of 193 nm. An immersion liquid which is suitable for example for that purpose is denoted by the name ‘Dekalin’. A further suitable immersion liquid is cyclohexane (nᵢₘₘ≈1.57 at 193 nm).

The last lens 43 at the image plane side of the projection lens 1 is a planoconvex lens with a convexly curved light entrance surface at the object plane side and is made from lutetium aluminum garnet (Lu₃Al₅O₁₂, LuAG). The last optical element at the image plane side is of a comparatively large radius, which can also lead to a large thickness. The following condition can be referred to as a criterion for that thickness:

0.8*y_{0, max}<d<1.5*y_{0, max} (3)

wherein y_{0, max} denotes the maximum object height, that is to say the maximum distance of an object field point from the optical axis (OA). In the illustrated example y_{0, max}=63.7 mm. For d there is a value of about 72.28 mm. Thus the foregoing condition (3) from which there follows for the illustrated embodiment a lower limit of 50.96 mm and an upper limit of 95.55 mm is satisfied.

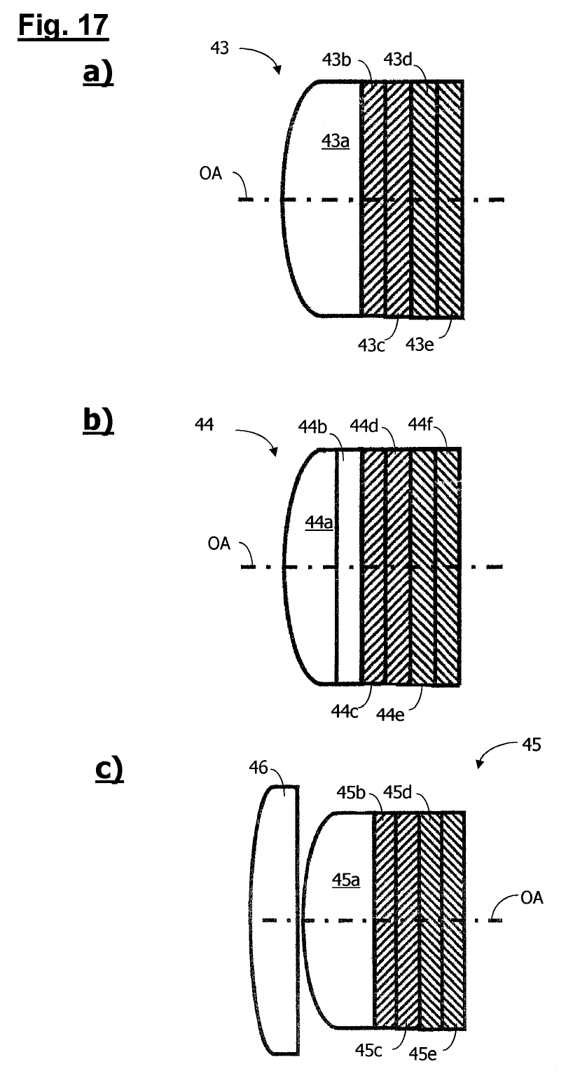

FIG. 17a shows a detailed lens section of the last lens 43 at the image side of the projection lens 1 of FIG. 16. The lens 43 is composed of a total of five lens elements 43a, 43b, 43c, 43d and 43e which are arranged in succession along the optical axis OA. In addition in the illustrated embodiment the respectively mutually following lens 43a-43e of the lens 43 are in direct contact with each other insofar as they are joined optically seamlessly together for example by wringing. Alternatively however those lens elements can also be separated by a gap. Table 12 shows the individual lens parameters of the lens elements 43a-43e. In that Table the number of the respective lens element surface is specified in column 1, the IBR-induced retardation (in nm/cm) of the material following the surface is specified in column 2, the material following the surface is specified in column 3 and the crystal orientation of the material following the surface is specified in column 4. Columns 5 through 10 of Table 12 specify the directional cosine for describing the rotation of the co-ordinate system initially identical to the media system fixed in relation to space (x, y, z) (or the co-ordinate system of the lens), into the co-ordinate system (x′, y′, z′) of the crystal, that is to say Y/alpha, Y/beta and Y/gamma, and Z/alpha, Z/beta and Z/gamma respectively specify the directional cosine of the Y/axis of the ‘new’ co-ordinate system of the crystal in relation to the ‘original’ co-ordinate system.

In FIG. 17a and Table 12 of the lens elements 43b-43e two respective ones of those elements in pairs involve the same crystal cut and are arranged rotated relative to each other about the optical axis OA. More precisely the second lens element 43b along the optical axis OA or in the light propagation direction and the third lens element 43c have a [100]-crystal cut, that is to say in those lens elements the [100]-crystal axis is parallel to the optical axis OA of the projection lens 1. The fourth lens element 43d along the optical axis OA or in the light propagation direction and the fifth lens elements 43e have a [111]-crystal cut, that is to say in those lens elements the [111]-crystal axis is parallel to the optical axis OA of the projection lens. Furthermore the lenses 43b and 43c involving the [100]-crystal cut are rotated relative to each other (‘clocked’) through an angle of 45° about the optical axis OA and the lenses 43d and 43e involving the [111]-crystal cut are arranged rotated relative to each other through an angle of 60° about the optical axis OA.

Although the above-mentioned rotary angles (‘clocking angles’) of the lenses involving the [111]-crystal cut (60°) and the lenses involving the [100]-crystal cut (45°) represent the optimum values for the selected arrangement in regard to minimising the IBR-induced residual retardation, it will be appreciated that the disclosure is not restricted to those angles as partial compensation can also already be achieved with differing rotary angles.

Furthermore the disclosure is generally not limited to the composition shown by reference to FIGS. 17a-c of the last lens at the image plane side, made up of a plurality of lens elements, but also embraces projection lenses in which the compensation elements described in greater detail hereinafter are also provided without the above-discussed optional configuration of the last lens at the image side.

FIG. 17b only differs from FIG. 17a in that provided between a first planoconex lens element 44a and a group of four plane-parallel lens elements 44c-44f which are rotated relative to each other in pairs similarly to FIG. 17a, there is a further lens element 44b for symmetrisation of the IBR-induced retardation of the first planoconvex lens element 44a. That further lens element 44b, like the first planoconex lens element 44a, involves a [100]-crystal cut and is arranged rotated with respect to the first lens element 44a through an angle of 45° about the optical axis OA.

An embodiment diagrammatically illustrated in FIG. 17c only differs from FIG. 17b in that a lens element 46 which is used for symmetrisation of the IBR-induced retardation of a planoconvex lens element 45a and which like a planoconvex lens element 45a involves a [100]-crystal cut and is arranged rotated with respect to that lens element 45a through an angle of 45° about the optical axis OA is provided in the light propagation direction upstream of that planoconvex lens element 45a and separately therefrom, in the form of a penultimate lens at the image plane side.

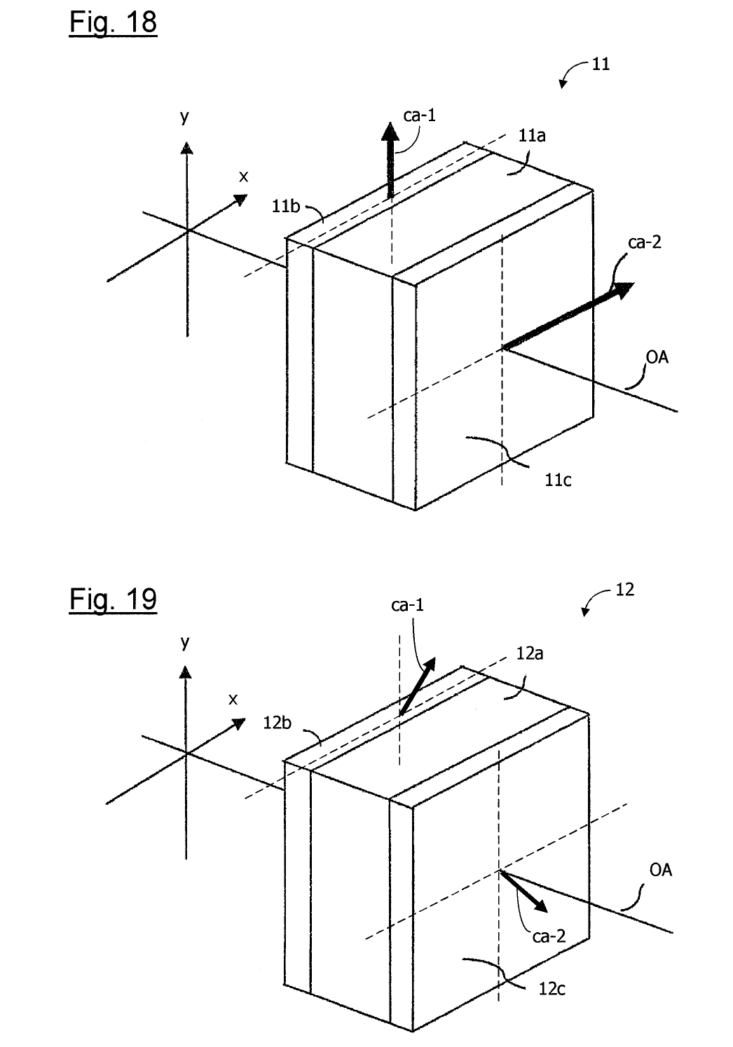

To compensate for the intrinsic birefringence caused by the last lens 43 at the image plane side, the projection lens 1 also has a plurality of compensation elements (in the illustrated embodiment three) at suitable positions along the optical axis OA, those compensation elements being identified by references 11, 12 and 41 in FIG. 16 and the structure thereof being discussed in greater detail hereinafter with reference to FIGS. 18 through 20.

Referring to FIG. 18 the compensation element 11 has two subelements 11b and 11c respectively of optically uniaxial material, in the illustrated embodiment magnesium fluoride (MgF₂), which are in the form of plane plates and which are wrung on both sides on a carrier plate 11a of quartz glass (SiO₂), the thickness thereof in the illustrated embodiment being selected to be identical to each other while their optical crystal axes identified by ca-1 and ca-2 respectively are oriented in a plane perpendicular to the optical axis identified by OA. In addition the optical crystal axes ca-1 and ca-2 of the subelements 11b and 11c are arranged in mutually perpendicular relationship, wherein in the illustrated embodiment the optical crystal axis ca-1 is oriented parallel to the y-axis and the optical crystal axis ca-2 is oriented parallel to the x-axis. The specifications of the compensation element 11 are summarised in Table 9.

Magnesium fluoride (MgF₂) is a birefringent material of optically positive character, which in the present case means that the extraordinary refractive index nₑ is greater than the ordinary refractive index mₒ, wherein for MgF₂ Δn=nₑ−nₒ≈0.0136 applies for example at a working wavelength of 193 nm. In the crystal orientation used, the birefringent action of MgF₂ is opposite to the action of the intrinsic birefringence of LuAG so that the retardation caused by MgF₂ by virtue of natural birefringence and the retardation caused by LuAG by virtue of intrinsic birefringence at least partially compensate each other.

MgF₂ is thus basically suitable as a material for the compensation of the IBR of LuAG. That IBR compensation is effected in accordance with the present disclosure however not by way of a given surface shape or a varying thickness profile but, as explained in the opening part of this specification, by way of the angle distribution in the beam pencil.

The consequence of the mutually perpendicular arrangement of the crystal axes ca-1 and ca-2 of the two subelements 11b and 11c is that what is referred to as the slow axis of birefringence (that is to say the axis with the greater refractive index n₁) in the subelement 11b is parallel to what is referred to as the fast axis of birefringence (that is to say the axis with the lower refractive index n₂) in the subelement 11c. Correspondingly, the fast axis of birefringence in the subelement 11b is parallel to the slow axis of birefringence in the subelement 11c.

Consequently the phase changes in the mutually perpendicular components of the electrical field strength vector, caused by the subelements 11b and 11c on a light beam passing through the compensation element 11 parallel to the optical axis OA, are of opposite sine and (with the same thickness of the subelements) are of equal value in terms of magnitude so that accordingly no retardation is induced along the optical axis OA by the joint action of the subelements 11b, 11c. The element 11 thus provides a change in the polarization state only for those light beams which pass through it at an angle different from zero relative to the optical axis OA.

The consequence of the plane-parallel configuration of the subelements 11b-11c or the carrier plate 11a is that the surface shape of the compensation element 11 does not have a disturbing influence on the optical imaging action or what is referred to as the scalar phase, as occurs for example in the case of a compensation element of variable thickness profile, and thus the compensation element 111 according to the disclosure does not make a destructive contribution to optical imaging. Production of the compensation element 11 can be effected in a simple manner by a respective MgF₂ plate of any thickness firstly being wrung on to both side faces of the SiO₂ carrier plate 11a, and by the former then being worked or removed to set the desired thickness, to give the subelements 11b, c.

The compensation element 12 shown in FIG. 19 is of a structure similar to the element 11, but in this case the optical crystal axes ca-1 and ca-2—which are also oriented in a plane perpendicular to the optical axis OA and also perpendicularly to each other—are rotated with respect to those of the element 11 in FIG. 18 through 45° about the optical axis OA (that is to say they are respectively arranged at an angle of 45° relative to the x-axis and y-axis respectively). The specifications of the compensation element 12 are summarised in Table 10.

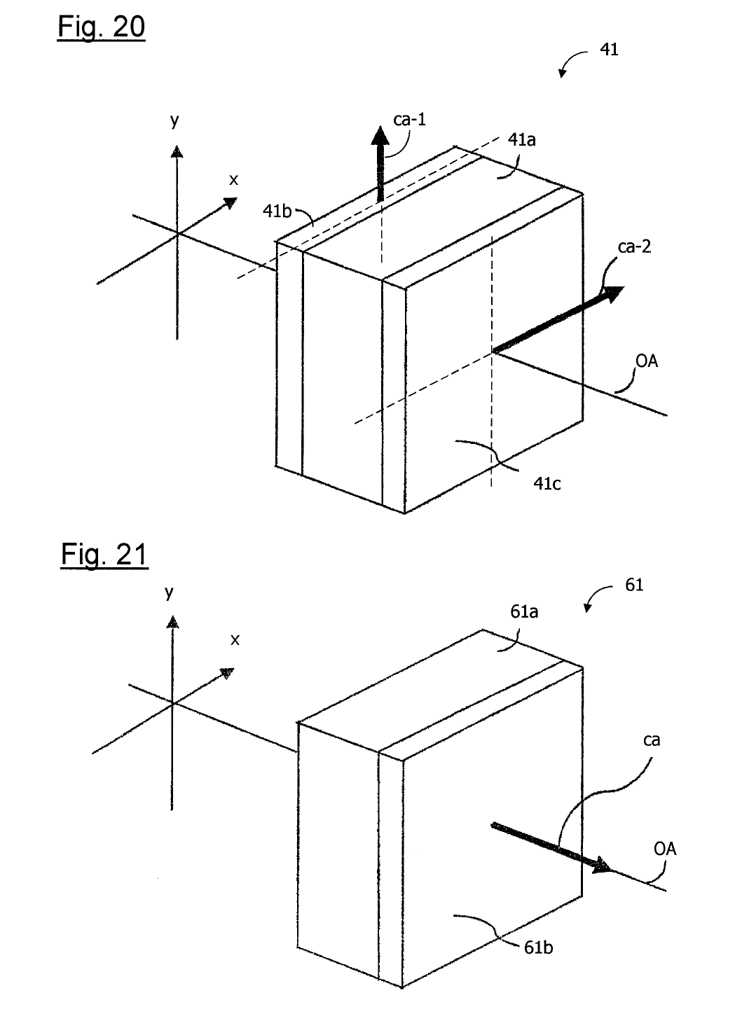

The compensation element 41 shown in FIG. 20 is also of a structure similar to the elements 11 and 12, in which respect the orientations of the optical crystal axes ca-1 and ca-2 in the element 41 are selected as in the element 11.

As shown in FIG. 16 the compensation elements 11 and 12 in the projection lens 1 are arranged in direct succession along the optical axis OA, more specifically in the first optical subsystem 10 between the object plane OP and the first refractive lens 13. As the beam path in that region is substantially telecentric (that is to say the principal ray extends parallel to the optical axis) the polarization-influencing action of the compensation elements 11 and 12 in that region is field-independent so that the compensation elements 11 and 12 arranged in that region (in the object space, that is to say between the object plane and the first refractive lens surface) are suitable in particular for the compensation of IBR contributions involving a constant field configuration.

The compensation element 41 is arranged in the third optical subsystem 30 between the refractive lenses 40 and 42.

For the compensation of IBR contributions involving a variable field configuration, that is to say for inducing a field-dependent retardation or compensation in respect of an IBR which varies over the field, optionally one or more compensation elements of the structure described with reference to FIGS. 18 through 20 are placed at a position in the beam path, at which the angles of the marginal rays differ little from each other or the principal ray is of a relatively small height. That condition is satisfied in particular in the proximity of the pupil plane PP2 within the third optical subsystem 30.

FIG. 21 shows a compensation element 61 in accordance with some embodiments of the disclosure. It includes a subelement 61b which is applied (for example wrung) on a carrier plate 61a of optically isotropic material (SiO₂) and which again is in the form of a plane plate of optically uniaxial material (for example MgF₂), in which case however as shown in FIG. 21 the optical crystal axis ca is oriented parallel to the optical axis oa. Consequently no retardation along the optical axis OA is also induced by the compensation element 61.

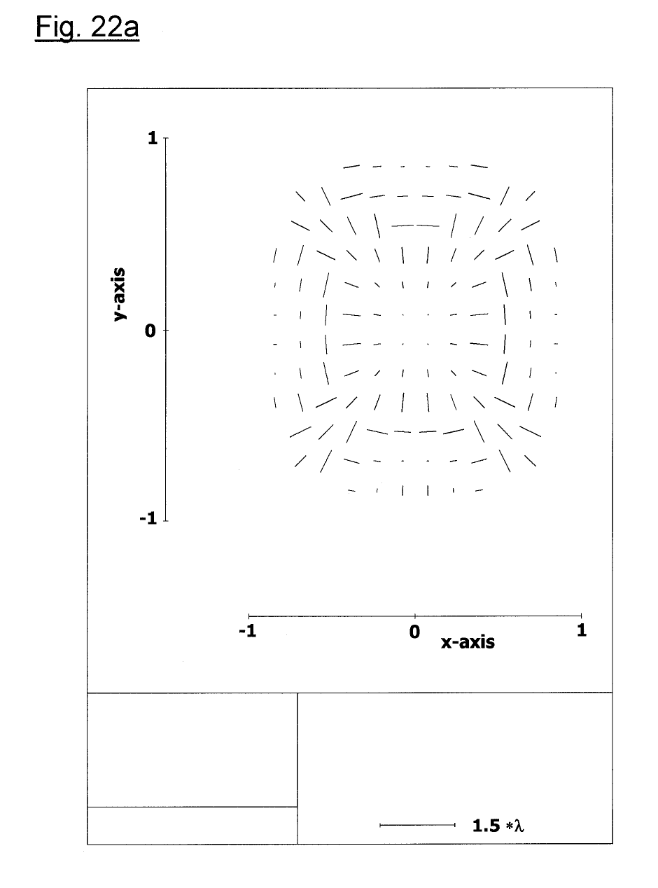

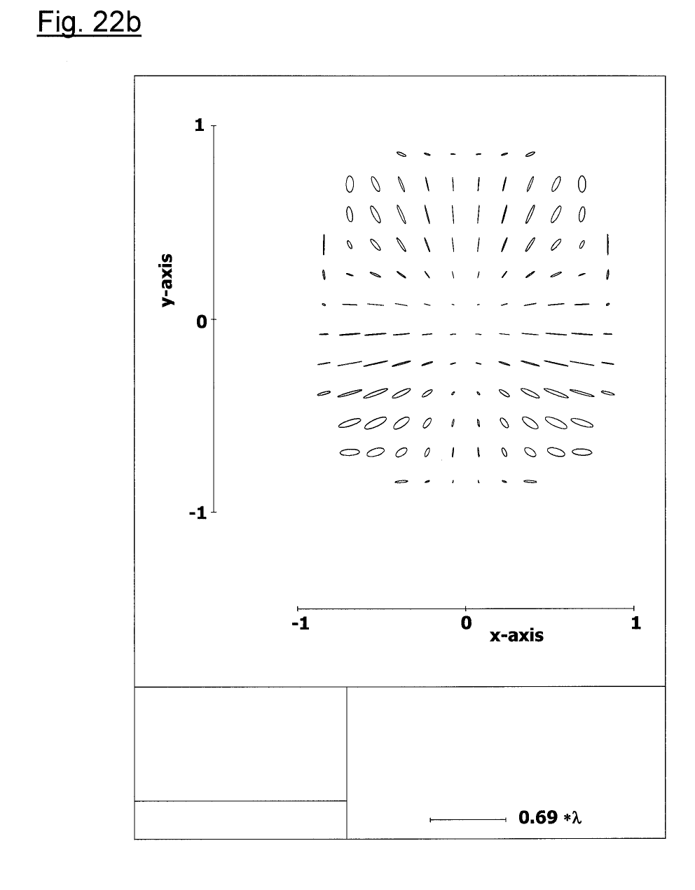

FIGS. 22a-b show the pupil distribution of the retardation (referred to as the ‘retardance pupil map’) for the last lens 43 at the image plane side of LuAG (FIG. 22a) and for the entire projection lens 100 respectively, that is to say having regard in particular to the IBR compensation according to the disclosure via the compensation elements 11, 12 and 41 (FIG. 22b). With the combination according to the disclosure, a reduction in the maximum values of retardation from about 200 nm to about 50 nm is achieved by the action of the compensation elements.

The above description of preferred embodiments has been given by way of example. A person skilled in the art will, however, not only understand the present disclosure and its advantages, but will also find suitable modifications thereof. Therefore, the present disclosure is intended to cover all such changes and modifications as far as falling within the spirit and scope of the disclosure as defined in the appended claims and the equivalents thereof.

TABLE 1
DESIGN DATA for FIG. 1
(NA = 1.55; wavelength λ = 193 nm)

| SURFACE | RADIUS | THICKNESS | MATERIAL | INDEX | SEMIDIAM. |
|---|---|---|---|---|---|
| 0 | 0.000000 | 52.291526 | | | 62.5 |
| 1 | 185.414915 | 36.606310 | SILUV | 1.560364 | 93.9 |
| 2 | −2368.330782 | 103.305956 | | | 94.5 |
| 3 | 1135.440971 | 81.730311 | SILUV | 1.560364 | 101.4 |
| 4 | −836.574481 | 7.626264 | | | 101.9 |
| 5 | 642.761068 | 10.166290 | SILUV | 1.560364 | 94.3 |
| 6 | −28777.509893 | 17.021812 | | | 92.4 |
| 7 | 374.784051 | 23.493394 | SILUV | 1.560364 | 88.9 |
| 8 | −739.574652 | 12.599110 | | | 86.7 |
| 9 | 0.000000 | 0.000000 | SILUV | 1.560364 | 82.0 |
| 10 | 0.000000 | 35.701682 | | | 82.0 |
| 11 | −287.062457 | 8.020868 | SILUV | 1.560364 | 87.6 |
| 12 | −260.605102 | 8.348886 | | | 89.8 |
| 13 | 356.037256 | 34.761348 | SILUV | 1.560364 | 102.3 |
| 14 | −1139.573155 | 45.988038 | | | 103.0 |
| 15 | −297.853763 | 10.898517 | SILUV | 1.560364 | 100.8 |
| 16 | −286.492576 | 442.012212 | | | 102.4 |
| 17 | −186.492728 | −232.661918 | REFL | | 162.7 |
| 18 | 213.357562 | 272.661219 | REFL | | 150.8 |
| 19 | 186.190755 | 63.407664 | SILUV | 1.560364 | 143.4 |
| 20 | 559.595962 | 102.212676 | | | 138.9 |
| 21 | 336.987586 | 10.146122 | SILUV | 1.560364 | 98.0 |
| 22 | 98.067417 | 59.917522 | | | 83.0 |
| 23 | 2014.227818 | 10.231531 | SILUV | 1.560364 | 83.9 |
| 24 | 209.706892 | 5.218396 | | | 88.7 |
| 25 | 187.199398 | 16.497859 | SILUV | 1.560364 | 90.5 |
| 26 | 563.378273 | 25.195888 | | | 92.4 |
| 27 | −358.535155 | 9.999385 | SILUV | 1.560364 | 95.4 |
| 28 | −369.270277 | 4.329131 | | | 104.5 |
| 29 | 6342.575536 | 49.942200 | SILUV | 1.560364 | 124.0 |
| 30 | −323.631832 | 0.997442 | | | 127.3 |
| 31 | −503.301175 | 35.880564 | SILUV | 1.560364 | 129.5 |
| 32 | −236.865310 | 0.997844 | | | 132.5 |
| 33 | −1601.468501 | 29.219759 | SILUV | 1.560364 | 133.0 |
| 34 | −298.758201 | 1.000000 | | | 134.0 |
| 35 | 808.661277 | 24.892404 | SILUV | 1.560364 | 130.1 |
| 36 | −2015.744411 | 1.000000 | | | 128.8 |
| 37 | 232.975060 | 41.179286 | SILUV | 1.560364 | 120.7 |
| 38 | 2382.195206 | 1.000000 | | | 116.6 |
| 39 | 192.288001 | 45.336304 | SILUV | 1.560364 | 110.2 |
| 40 | −1085.511304 | 1.000000 | | | 107.6 |
| 41 | 139.778134 | 25.996093 | SILUV | 1.560364 | 84.0 |
| 42 | 482.429105 | 1.000000 | | | 78.8 |
| 43 | 83.925256 | 60.000000 | LUAG | 2.143500 | 60.2 |
| 44 | 0.000000 | 3.100000 | HIINDEX | 1.650000 | 24.1 |
| 45 | 0.000000 | 0.000000 | | | 15.6 |

TABLE 2
ASPHERICAL CONSTANTS for FIG. 1

| | SRF | | | | |
|---|---|---|---|---|---|
| | 1 | 4 | 6 | 8 | 12 |
| K | 0 | 0 | 0 | 0 | 0 |
| C1 | −6.447148E−08 | −1.825065E−07 | 7.288539E−08 | 1.468587E−07 | −8.341858E−09 |
| C2 | 3.904192E−12 | 1.875167E−12 | 4.464300E−12 | −6.136079E−12 | 3.035481E−12 |
| C3 | −1.742805E−16 | 9.471479E−16 | −3.280221E−16 | −6.664138E−16 | 1.950958E−16 |
| C4 | −2.099949E−21 | −3.417617E−20 | −1.914887E−20 | −1.246213E−20 | 6.966650E−21 |
| C5 | 1.526611E−24 | −3.618274E−24 | 5.811541E−24 | 4.088277E−24 | 1.855444E−24 |
| C6 | −1.341115E−28 | 3.456865E−28 | −6.504073E−28 | 7.614765E−29 | −1.407831E−28 |
| C7 | 3.864081E−33 | −8.427102E−33 | 3.066152E−32 | −1.622968E−32 | −3.044932E−33 |
| | SRF | | | | |
| | 14 | 15 | 17 | 18 | 20 |
| K | 0 | 0 | −1.9096 | −0.5377 | 0 |
| C1 | −5.818454E−08 | −3.254341E−08 | −2.658999E−08 | −1.536262E−10 | −8.785831E−09 |
| C2 | −2.919573E−13 | 3.968952E−13 | 1.561056E−13 | −2.682680E−15 | 5.646919E−13 |
| C3 | −3.209102E−17 | −2.807842E−17 | −4.132973E−18 | −3.645198E−20 | −6.454482E−18 |
| C4 | 3.126755E−22 | 4.190647E−21 | 5.067872E−23 | 1.499409E−24 | −2.410154E−22 |
| C5 | 3.818902E−25 | −3.741144E−25 | −9.622504E−28 | 1.222432E−28 | 1.104073E−26 |
| C6 | −8.486242E−30 | 3.532694E−29 | 1.189984E−32 | −6.277586E−33 | −2.437139E−31 |
| C7 | −2.419178E−34 | −1.204525E−33 | −1.166383E−37 | 1.594458E−37 | 2.163229E−36 |
| | SRF | | | | |
| | 21 | 23 | 25 | 28 | 29 |
| K | 0 | 0 | 0 | 0 | 0 |
| C1 | 6.965245E−08 | −9.869141E−08 | −3.835477E−08 | 1.214957E−07 | 5.348537E−08 |
| C2 | −2.619816E−13 | 3.468310E−12 | −7.670508E−12 | 1.647962E−12 | 2.629539E−12 |
| C3 | 9.867326E−18 | −1.114544E−15 | 7.876676E−16 | −5.350727E−16 | −5.067530E−16 |
| C4 | −6.513277E−21 | 1.484338E−19 | −1.643323E−19 | 3.115581E−20 | 4.241183E−20 |
| C5 | 1.222326E−25 | −2.541221E−23 | 1.862076E−23 | −6.028858E−24 | −2.286931E−24 |
| C6 | −7.772178E−30 | 2.753259E−27 | −1.538795E−27 | 5.836667E−28 | 6.869266E−29 |
| C7 | −1.760691E−33 | −1.058751E−31 | 6.396967E−32 | −1.784413E−32 | −8.391190E−34 |

| | SRF | | | | | |
|---|---|---|---|---|---|---|
| | 31 | 33 | 36 | 38 | 40 | 42 |
| K | 0 | 0 | 0 | 0 | 0 | 0 |
| C1 | 3.570488E−09 | −1.108288E−08 | 1.098120E−08 | 3.498535E−09 | 4.009017E−08 | 6.190270E−09 |
| C2 | −2.899790E−13 | −5.556755E−13 | −8.319264E−13 | 1.277784E−12 | −5.714125E−12 | 1.866031E−11 |
| C3 | 1.081327E−16 | −3.884368E−18 | 3.311901E−17 | −7.357487E−17 | 6.202718E−16 | −3.186549E−15 |
| C4 | −1.172829E−20 | 1.842426E−21 | 7.733186E−23 | 1.115535E−21 | −5.344939E−20 | 5.219881E−19 |
| C5 | 2.404194E−25 | 3.001406E−27 | −1.051458E−26 | 2.894369E−25 | 3.354852E−24 | −6.008898E−23 |
| C6 | 1.461820E−29 | −7.804121E−30 | −4.556477E−30 | −1.579978E−29 | −1.359158E−28 | 4.502251E−27 |
| C7 | −5.103661E−34 | 2.042295E−34 | 1.779547E−34 | 3.499951E−34 | 2.690400E−33 | −1.632255E−31 |

TABLE 3
DESIGN DATA for FIG. 6
(NA = 1.55; wavelength λ = 193 nm)

| SURFACE | RADIUS | THICKNESS | MATERIAL | SEMIDIAMETER | TYP |
|---|---|---|---|---|---|
| 0 | 0.000000000 | 29.999023268 | AIR | 63.700 | |
| 1 | 0.000000000 | −0.022281351 | AIR | 74.345 | |
| 2 | 163.805749708 | 59.084774432 | SIO2V | 82.881 | |
| 3 | 105544.356800000 | 38.071845275 | AIR | 82.348 | |
| 4 | 101.870621340 | 65.572103284 | SIO2V | 82.073 | |
| 5 | −378.651946635 | 19.045416421 | AIR | 73.980 | |
| 6 | 370.653031677 | 12.447639670 | SIO2V | 52.927 | |
| 7 | −993.033551292 | 32.139483086 | AIR | 48.837 | |
| 8 | 0.000000000 | 9.999160574 | SIO2V | 56.110 | |
| 9 | 0.000000000 | 19.324564558 | AIR | 59.075 | |
| 10 | −192.850248976 | 9.999320401 | SIO2V | 63.500 | |
| 11 | −1410.323019430 | 0.999158407 | AIR | 71.319 | |
| 12 | 1101.723186800 | 39.051691649 | SIO2V | 76.269 | |
| 13 | −142.162593435 | 29.666310134 | AIR | 80.286 | |
| 14 | −374.506254334 | 22.829716703 | SIO2V | 88.413 | |
| 15 | −168.324621807 | 37.497577013 | AIR | 90.450 | |
| 16 | 0.000000000 | 230.203631062 | AIR | 95.221 | |
| 17 | −176.791197798 | −230.203631062 | AIR | 154.830 | REFL |
| 18 | 199.707895095 | 230.203631062 | AIR | 153.593 | REFL |
| 19 | 0.000000000 | 37.494077929 | AIR | 112.204 | |
| 20 | 154.146969466 | 37.014031773 | SIO2V | 108.045 | |
| 21 | 211.115292083 | 67.729859113 | AIR | 104.060 | |
| 22 | −417.157172821 | 9.999663284 | SIO2V | 87.647 | |
| 23 | 856.949969334 | 17.811529642 | AIR | 84.621 | |
| 24 | −461.630793169 | 9.999535405 | SIO2V | 83.829 | |
| 25 | 147.214334496 | 18.694156475 | AIR | 83.322 | |
| 26 | 188.563462966 | 13.376498541 | SIO2V | 86.613 | |
| 27 | 339.263859097 | 30.033832457 | AIR | 89.361 | |
| 28 | 55251.899029700 | 9.999840425 | SIO2V | 101.282 | |
| 29 | 324.218921543 | 11.074103655 | AIR | 110.546 | |
| 30 | 329.158897131 | 24.176827559 | SIO2V | 114.218 | |
| 31 | −1039.447544530 | 12.107569757 | AIR | 118.456 | |
| 32 | −1049.536733250 | 66.006337123 | SIO2V | 124.794 | |
| 33 | −161.348224543 | 0.998960784 | AIR | 130.266 | |
| 34 | −22578.425397200 | 19.907600934 | SIO2V | 142.663 | |
| 35 | −573.265324288 | 0.997820041 | AIR | 144.264 | |
| 36 | 272.154399646 | 74.960165499 | SIO2V | 152.983 | |
| 37 | −648.611591116 | −3.000147526 | AIR | 151.527 | |
| 38 | 0.000000000 | −0.362184752 | AIR | 144.818 | |
| 39 | 0.000000000 | 3.500000000 | AIR | 144.972 | |
| 40 | 0.000000000 | 0.017112000 | SAPHIR | 143.886 | UNIAXIAL |
| 41 | 0.000000000 | 0.017112000 | SAPHIR | 143.883 | UNIAXIAL |
| 42 | 0.000000000 | 0.017112000 | SAPHIR | 143.881 | UNIAXIAL |
| 43 | 0.000000000 | 0.017112000 | SAPHIR | 143.878 | UNIAXIAL |
| 44 | 0.000000000 | 0.017112000 | SAPHIR | 143.876 | UNIAXIAL |
| 45 | 0.000000000 | 0.017112000 | SAPHIR | 143.873 | UNIAXIAL |
| 46 | 0.000000000 | 6.904230000 | AIR | 143.871 | |
| 47 | 186.233344043 | 64.553742054 | SIO2V | 127.050 | |
| 48 | −817.629991875 | 1.838842051 | AIR | 122.346 | |
| 49 | 266.505780369 | 21.498553774 | SIO2V | 97.456 | |
| 50 | 1203.454749450 | 1.057097140 | AIR | 89.342 | |
| 51 | 92.026522503 | 72.367050294 | HINDSOL | 67.253 | CUBIC |
| 52 | 0.000000000 | 3.100206000 | HINDLIQ | 23.494 | |
| 53 | 0.000000000 | 0.000000000 | HINDLIQ | 15.959 | |

TABLE 4
ASPHERICAL CONSTANTS for FIG. 6

| | SURFACE NR. |
|---|---|
| | 2 |
| K | 0.0000 |
| C1 | 3.27717834e−008 |
| C2 | −4.89617715e−012 |
| C3 | 3.73996005e−016 |
| C4 | −2.37878831e−020 |
| C5 | 8.57925867e−025 |
| C6 | −9.04960217e−030 |
| C7 | 0.00000000e+000 |
| C8 | 0.00000000e+000 |
| C9 | 0.00000000e+000 |
| | SURFACE NR. |
| | 5 |
| K | 0.0000 |
| C1 | 6.50275226e−008 |
| C2 | 3.61801093e−012 |
| C3 | 1.02240864e−015 |
| C4 | −1.87353151e−019 |
| C5 | 8.82155787e−024 |
| C6 | −7.16445215e−029 |
| C7 | 0.00000000e+000 |
| C8 | 0.00000000e+000 |
| C9 | 0.00000000e+000 |
| | SURFACE NR. |
| | 7 |
| K | 0.0000 |
| C1 | 1.88065119e−007 |
| C2 | 1.92544339e−011 |
| C3 | 1.05639396e−014 |
| C4 | −3.85644447e−018 |
| C5 | 1.76463375e−021 |
| C6 | −2.78164496e−026 |
| C7 | 0.00000000e+000 |
| C8 | 0.00000000e+000 |
| C9 | 0.00000000e+000 |
| | SURFACE NR. |
| | 11 |
| K | 0.0000 |
| C1 | −6.13052340e−008 |
| C2 | −7.27041902e−013 |
| C3 | −2.98818117e−016 |
| C4 | 4.72904649e−021 |
| C5 | −3.26324829e−025 |
| C6 | 9.20302500e−030 |
| C7 | 0.00000000e+000 |
| C8 | 0.00000000e+000 |
| C9 | 0.00000000e+000 |
| | SURFACE NR. |
| | 15 |
| K | 0.0000 |
| C1 | 1.81116410e−008 |
| C2 | 1.46342750e−012 |
| C3 | 9.16966554e−017 |
| C4 | 2.17610192e−021 |
| C5 | 3.66548751e−025 |
| C6 | −1.09508590e−029 |
| C7 | 0.00000000e+000 |
| C8 | 0.00000000e+000 |
| C9 | 0.00000000e+000 |
| | SURFACE NR. |
| | 17 |
| K | −1.4693 |
| C1 | −2.06488339e−008 |
| C2 | 1.16939811e−014 |
| C3 | −1.28854467e−018 |
| C4 | −2.18667724e−024 |
| C5 | −2.11424143e−029 |
| C6 | −2.63669751e−033 |
| C7 | 0.00000000e+000 |
| C8 | 0.00000000e+000 |
| C9 | 0.00000000e+000 |
| | SURFACE NR. |
| | 18 |
| K | −1.4756 |
| C1 | 1.81134384e−008 |
| C2 | 4.18803124e−014 |
| C3 | 1.13727194e−018 |
| C4 | 1.05429895e−023 |
| C5 | −7.51318112e−029 |
| C6 | 5.73990187e−033 |
| C7 | 0.00000000e+000 |
| C8 | 0.00000000e+000 |
| C9 | 0.00000000e+000 |
| | SURFACE NR. |
| | 21 |
| K | 0.0000 |
| C1 | −6.50775113e−008 |
| C2 | −1.42875005e−012 |
| C3 | 2.44348063e−017 |
| C4 | 2.69349478e−021 |
| C5 | −6.45183994e−026 |
| C6 | −1.06542172e−030 |
| C7 | 0.00000000e+000 |
| C8 | 0.00000000e+000 |
| C9 | 0.00000000e+000 |
| | SURFACE NR. |
| | 22 |
| K | 0.0000 |
| C1 | 3.25656570e−008 |
| C2 | −9.80151934e−012 |
| C3 | 4.72663722e−016 |
| C4 | −3.37084211e−020 |
| C5 | 5.44443713e−024 |
| C6 | −2.69886851e−028 |
| C7 | 0.00000000e+000 |
| C8 | 0.00000000e+000 |
| C9 | 0.00000000e+000 |
| | SURFACE NR. |
| | 26 |
| K | 0.0000 |
| C1 | −1.25873172e−007 |
| C2 | 5.07729011e−013 |
| C3 | −4.31596804e−016 |
| C4 | 3.40710175e−020 |
| C5 | −1.09371424e−024 |
| C6 | 7.19441882e−029 |
| C7 | 0.00000000e+000 |
| C8 | 0.00000000e+000 |
| C9 | 0.00000000e+000 |
| | SURFACE NR. |
| | 29 |
| K | 0.0000 |
| C1 | −1.84342902e−008 |
| C2 | 2.53638171e−012 |
| C3 | −5.99368498e−016 |
| C4 | 3.86624579e−020 |
| C5 | −1.20898381e−024 |
| C6 | 8.96652964e−030 |
| C7 | 0.00000000e+000 |
| C8 | 0.00000000e+000 |
| C9 | 0.00000000e+000 |
| | SURFACE NR. |
| | 30 |
| K | 0.0000 |
| C1 | −8.61879968e−008 |
| C2 | 3.39493867e−012 |
| C3 | −3.28195033e−016 |
| C4 | 2.10606123e−020 |
| C5 | −1.04723087e−024 |
| C6 | 2.62244522e−029 |
| C7 | 0.00000000e+000 |
| C8 | 0.00000000e+000 |
| C9 | 0.00000000e+000 |
| | SURFACE NR. |
| | 32 |
| K | 0.0000 |
| C1 | −1.37987785e−008 |
| C2 | 9.93396958e−013 |
| C3 | −6.33630634e−017 |
| C4 | −8.67433197e−022 |
| C5 | 2.93215222e−025 |
| C6 | −1.28960244e−029 |
| C7 | 0.00000000e+000 |
| C8 | 0.00000000e+000 |
| C9 | 0.00000000e+000 |
| | SURFACE NR. |
| | 34 |
| K | 0.0000 |
| C1 | −2.99481436e−008 |
| C2 | 1.36597095e−013 |
| C3 | 1.91457881e−017 |
| C4 | 3.73289075e−022 |
| C5 | 2.97027585e−026 |
| C6 | −1.84061701e−030 |
| C7 | 0.00000000e+000 |
| C8 | 0.00000000e+000 |
| C9 | 0.00000000e+000 |
| | SURFACE NR. |
| | 37 |
| K | 0.0000 |
| C1 | −4.09482708e−009 |
| C2 | −1.82941742e−013 |
| C3 | 2.20416868e−017 |
| C4 | 6.34184593e−024 |
| C5 | −2.87479049e−026 |
| C6 | 4.96786571e−031 |
| C7 | 0.00000000e+000 |
| C8 | 0.00000000e+000 |
| C9 | 0.00000000e+000 |
| | SURFACE NR. |
| | 48 |
| K | 0.0000 |
| C1 | 2.74613205e−008 |
| C2 | −6.95594493e−013 |
| C3 | −7.38008203e−017 |
| C4 | 1.06403973e−020 |
| C5 | −4.67997489e−025 |
| C6 | 8.19502507e−030 |
| C7 | 0.00000000e+000 |
| C8 | 0.00000000e+000 |
| C9 | 0.00000000e+000 |
| | SURFACE NR. |
| | 50 |
| K | 0.0000 |
| C1 | 3.61747962e−008 |
| C2 | 4.73189475e−012 |
| C3 | −9.39579701e−018 |
| C4 | 1.36373597e−021 |
| C5 | 4.58112541e−025 |
| C6 | 2.49231914e−029 |
| C7 | 0.00000000e+000 |
| C8 | 0.00000000e+000 |
| C9 | 0.00000000e+000 |

TABLE 5
Coefficients for Zernike polynomial-terms for free-form
surfaces of FIG. 9

| Sur- | |
|---|---|
| face | Specifications and Birefringence data |
| 41 | ZP2: 1.3464E−04 ZP6: 7.0720E−03 ZP7: −3.0436E−04 |
| | ZP8: −8.6148E−05 ZP14: −2.7788E−03 ZP15: 9.9238E−05 |
| | ZP16: 1.6627E−04 ZP17: 9.6187E−05 ZP18: 1.6835E−04 |
| | ZP26: 7.2238E−04 ZP27: −5.4027E−05 ZP31: −8.2896E−05 |
| | ZP32: 9.2226E−05 ZP42: −1.3009E−04 ZP50: 2.2443E−05 |
| | NRADIUS: 1.4442E+02 |
| | BIREFRINGENCE: −0.01130 |
| | CRYSTAL AXIS: 0.707107 −0.707107 0.000000 |
| 42 | BIREFRINGENCE: −0.01130 |
| | CRYSTAL AXIS: 0.000000 1.000000 0.000000 |
| 43 | ZP1: −2.2103E−05 ZP3: 3.1465E−05 ZP4: −2.6569E−03 |
| | ZP5: 1.2076E−05 ZP9: −2.0832E−04 ZP10: 2.4878E−04 |
| | ZP11: −1.1947E−04 ZP12: 2.2720E−03 ZP13: −4.8980E−05 |
| | ZP19: −1.6463E−05 ZP20: 2.6678E−04 ZP21: 1.2347E−04 |
| | ZP23: −1.0043E−04 ZP24: −7.8608E−04 ZP25: −4.9355E−05 |
| | ZP33: −8.3815E−05 ZP34: 2.9550E−04 ZP40: 6.6448E−04 |
| | ZP41: −3.2893E−05 ZP51: −8.6576E−05 ZP61: −1.4676E−06 |
| | NRADIUS: 1.4437E+02 |
| | BIREFRINGENCE: −0.01130 |
| | CRYSTAL AXIS: 1.000000 0.000000 0.000000 |
| 44 | BIREFRINGENCE: −0.01130 |
| | CRYSTAL AXIS: 0.707107 0.707107 0.000000 |
| 45 | ZP2: 9.9565E−05 ZP6: 7.1135E−03 ZP7: −5.2388E−04 |
| | ZP8: −1.9099E−04 ZP14: −2.7880E−03 ZP15: 5.6141E−05 |
| | ZP16: −1.2722E−04 ZP17: 1.0277E−04 ZP18: −2.1371E−04 |
| | ZP26: 6.8543E−04 ZP27: −1.0003E−04 ZP31: −5.4322E−06 |
| | ZP32: −2.5020E−04 ZP42: −1.4399E−04 ZP50: −1.2186E−04 |
| | NRADIUS: 1.4433E+02 |
| | BIREFRINGENCE: −0.01130 |
| | CRYSTAL AXIS: 0.707107 −0.707107 0.000000 |
| 51 | INTRINSIC BIREFRINGENCE 0.3010E−05 |
| | CUBIC AXIS ORIENTATION: Y: 0.707107 0.707107 0.000000 |
| | Z: −0.707107 0.707107 0.000000 |

TABLE 7
(Design data for FIG. 16)

| Surface | Radius | Thickness | Typ | Material | Index | Semidiameter |
|---|---|---|---|---|---|---|
| OBJ: | ∞ | 30.000001 | | | | 63.7 |
| 1: | ∞ | 0.007313 | | | | 76.342 |
| 2: | ∞ | 0.072008 | | MGF2 | 1.4274127 | 76.345 |
| 3: | ∞ | 4.5 | | SIO2 | 1.5607857 | 76.366 |
| 4: | ∞ | 0.072008 | | MGF2 | 1.4274127 | 77.522 |
| 5: | ∞ | 0.1 | | | | 77.542 |
| 6: | ∞ | 0.012975 | | MGF2 | 1.4274127 | 77.584 |
| 7: | ∞ | 3.5 | | SIO2 | 1.5607857 | 77.588 |
| 8: | ∞ | 0.012975 | | MGF2 | 1.4274127 | 78.487 |
| 9: | ∞ | 0.1 | | | | 78.491 |
| 10: | 164.1887 | 55.656939 | | SIO2 | 1.5607857 | 90.329 |
| 11: | −11611.44619 | 36.178871 | | | | 89.565 |
| 12: | 101.68117 | 65.572103 | | SIO2 | 1.5607857 | 85.565 |
| 13: | −391.58904 | 19.176474 | | | | 78.526 |
| 14: | 379.9076 | 12.556983 | | SIO2 | 1.5607857 | 53.245 |
| 15: | −1052.68959 | 31.916774 | | | | 47.986 |
| 16: | ∞ | 9.999161 | | SIO2 | 1.5607857 | 57.836 |
| 17: | ∞ | 19.324565 | | | | 61.216 |
| 18: | −192.89036 | 10.019516 | | SIO2 | 1.5607857 | 65.709 |
| 19: | −1448.29104 | 1.337791 | | | | 74.344 |
| 20: | 1131.04789 | 40.512981 | | SIO2 | 1.5607857 | 80.311 |
| 21: | −141.25791 | 28.196638 | | | | 83.968 |
| 22: | −372.39559 | 23.570712 | | SIO2 | 1.5607857 | 92.081 |
| 23: | −166.28278 | 33.48658 | | | | 93.997 |
| 24: | ∞ | 230.10523 | | | | 97.574 |
| 25: | −176.21066 | −230.1052 | REFL | | | 158.077 |
| 26: | 200.17335 | 230.10523 | REFL | | | 157.458 |
| 27: | ∞ | 38.365735 | | | | 114.889 |
| 28: | 153.53976 | 37.279076 | | SIO2 | 1.5607857 | 110.979 |
| 29: | 212.12477 | 65.883519 | | | | 107.671 |
| 30: | −406.22169 | 10.516693 | | SIO2 | 1.5607857 | 91.668 |
| 31: | 912.48012 | 17.826947 | | | | 88.172 |
| 32: | −456.33483 | 10.068997 | | SIO2 | 1.5607857 | 87.419 |
| 33: | 146.56694 | 19.163152 | | | | 86.387 |
| 34: | 186.36894 | 11.98645 | | SIO2 | 1.5607857 | 89.016 |
| 35: | 338.557 | 29.6292 | | | | 91.506 |
| 36: | 425406.9563 | 10.000173 | | SIO2 | 1.5607857 | 102.883 |
| 37: | 325.3983 | 11.327972 | | | | 112.247 |
| 38: | 329.16326 | 24.191698 | | SIO2 | 1.5607857 | 116.013 |
| 39: | −1061.27053 | 11.942494 | | | | 120.067 |
| 40: | −1041.27121 | 65.310795 | | SIO2 | 1.5607857 | 125.476 |
| 41: | −161.70157 | 1.078012 | | | | 130.687 |
| 42: | −20002.40492 | 20.840056 | | SIO2 | 1.5607857 | 142.508 |
| 43: | −576.10984 | 2.014794 | | | | 144.203 |
| 44: | 272.97804 | 76.574778 | | SIO2 | 1.5607857 | 152.123 |
| 45: | −650.23797 | −2.70976 | | | | 150.199 |
| STO: | ∞ | −0.362185 | | | | 143.335 |
| 47: | ∞ | 5.292444 | | | | 143.494 |
| 48: | 186.47545 | 64.613787 | | SIO2 | 1.5607857 | 127.915 |
| 49: | −812.70252 | 1.204298 | | | | 123.545 |
| 50: | ∞ | 0.017 | | MGF2 | 1.4274127 | 117.917 |
| 51: | ∞ | 4.5 | | SIO2 | 1.5607857 | 117.907 |
| 52: | ∞ | 0.017 | | MGF2 | 1.4274127 | 115.720 |
| 53: | ∞ | 0.1 | | | | 115.711 |
| 54: | 263.98731 | 20.956959 | | SIO2 | 1.5607857 | 98.006 |
| 55: | 1277.80769 | 1 | | | | 90.691 |
| 56: | 91.88611 | 42.281164 | | LuAG | 2.1500000 | 68.247 |
| 57: | ∞ | 7 | | LuAG | 2.1500000 | 55.811 |
| 58: | ∞ | 7 | | LuAG | 2.1500000 | 48.508 |
| 59: | ∞ | 8 | | LuAG | 2.1500000 | 41.206 |
| 60: | ∞ | 8 | | LuAG | 2.1500000 | 32.860 |
| 61: | ∞ | 3.1 | | “High- | 1.6500232 | 24.514 |
| | | | | Index” | | |
| | | | | liquid | | |
| IMAGE: | ∞ | 0 | | | | 15.926 |

TABLE 8
(Aspheric constants for FIG. 16)

| | | | | | | | |
|---|---|---|---|---|---|---|---|
| 10: | | | | | | | |
| K: | 0.0000000E+00 | | | | | | |
| C1: | 3.7336200E−08 | C2: | −4.4401500E−12 | C3: | 2.9171300E−16 | C4: | −1.7540900E−20 |
| C5: | 6.8890600E−25 | C6: | −9.5900400E−30 | C7: | 0.0000000E+00 | C8: | 0.0000000E+00 |
| 13: | | | | | | | |
| K: | 0.0000000E+00 | | | | | | |
| C1: | 6.5222200E−08 | C2: | 3.6994700E−12 | C3: | 1.1802300E−15 | C4: | −2.2218800E−19 |
| C5: | 1.1546500E−23 | C6: | −1.1707900E−28 | C7: | 0.0000000E+00 | C8: | 0.0000000E+00 |
| 15: | | | | | | | |
| K: | 0.0000000E+00 | | | | | | |
| C1: | 1.9000500E−07 | C2: | 1.9024200E−11 | C3: | 1.2035100E−14 | C4: | −4.5007100E−18 |
| C5: | 2.0023300E−21 | C6: | −3.5949900E−26 | C7: | 0.0000000E+00 | C8: | 0.0000000E+00 |
| 19: | | | | | | | |
| K: | 0.0000000E+00 | | | | | | |
| C1: | −6.0107300E−08 | C2: | −7.6461600E−13 | C3: | −2.8680000E−16 | C4: | 6.1936600E−21 |
| C5: | −5.4389000E−25 | C6: | 1.0578400E−29 | C7: | 0.0000000E+00 | C8: | 0.0000000E+00 |
| 23: | | | | | | | |
| K: | 0.0000000E+00 | | | | | | |
| C1: | 1.7661500E−08 | C2: | 1.4085900E−12 | C3: | 9.5203300E−17 | C4: | 1.6703100E−21 |
| C5: | 3.6347000E−25 | C6: | −8.4793200E−30 | C7: | 0.0000000E+00 | C8: | 0.0000000E+00 |
| 25: | | | | | | | |
| K: | −1.4654780E+00 | | | | | | |
| C1: | −2.0682800E−08 | C2: | 1.2072300E−14 | C3: | −1.2363600E−18 | C4: | −3.7803100E−24 |
| C5: | −2.2812300E−29 | C6: | −1.5952700E−33 | C7: | 0.0000000E+00 | C8: | 0.0000000E+00 |
| 26: | | | | | | | |
| K: | −1.4798370E+00 | | | | | | |
| C1: | 1.8070900E−08 | C2: | 4.1664600E−14 | C3: | 1.0508200E−18 | C4: | 1.6805700E−23 |
| C5: | −2.8199900E−28 | C6: | 8.3093600E−33 | C7: | 0.0000000E+00 | C8: | 0.0000000E+00 |
| 29: | | | | | | | |
| K: | 0.0000000E+00 | | | | | | |
| C1: | −6.4136800E−08 | C2: | −1.4516900E−12 | C3: | 1.9862500E−17 | C4: | 3.2131100E−21 |
| C5: | −1.2110900E−25 | C6: | 6.0192800E−31 | C7: | 0.0000000E+00 | C8: | 0.0000000E+00 |
| 30: | | | | | | | |
| K: | 0.0000000E+00 | | | | | | |
| C1: | 2.8034400E−08 | C2: | −9.8102200E−12 | C3: | 4.5699200E−16 | C4: | −2.7810000E−20 |
| C5: | 4.9079000E−24 | C6: | −2.5940700E−28 | C7: | 0.0000000E+00 | C8: | 0.0000000E+00 |
| 34: | | | | | | | |
| K: | 0.0000000E+00 | | | | | | |
| C1: | −1.2432100E−07 | C2: | 4.5750500E−13 | C3: | −4.3215300E−16 | C4: | 3.0522200E−20 |
| C5: | −1.0232800E−24 | C6: | 5.6918300E−29 | C7: | 0.0000000E+00 | C8: | 0.0000000E+00 |
| 37: | | | | | | | |
| K: | 0.0000000E+00 | | | | | | |
| C1: | −1.8298100E−08 | C2: | 2.5124500E−12 | C3: | −6.0628900E−16 | C4: | 3.8069800E−20 |
| C5: | −1.1752300E−24 | C6: | 8.3471000E−30 | C7: | 0.0000000E+00 | C8: | 0.0000000E+00 |
| 38: | | | | | | | |
| K: | 0.0000000E+00 | | | | | | |
| C1: | −8.6045600E−08 | C2: | 3.3958400E−12 | C3: | −3.3045300E−16 | C4: | 2.1239900E−20 |
| C5: | −1.0373500E−24 | C6: | 2.6353800E−29 | C7: | 0.0000000E+00 | C8: | 0.0000000E+00 |
| 40: | | | | | | | |
| K: | 0.0000000E+00 | | | | | | |
| C1: | −1.4531300E−08 | C2: | 9.4625900E−13 | C3: | −5.8769400E−17 | C4: | −1.0424000E−21 |
| C5: | 2.8270400E−25 | C6: | −1.2925700E−29 | C7: | 0.0000000E+00 | C8: | 0.0000000E+00 |
| 42: | | | | | | | |
| K: | 0.0000000E+00 | | | | | | |
| C1: | −2.9853000E−08 | C2: | 1.6057100E−13 | C3: | 1.9628100E−17 | C4: | 3.7565800E−22 |
| C5: | 2.9295800E−26 | C6: | −1.9531000E−30 | C7: | 0.0000000E+00 | C8: | 0.0000000E+00 |
| 45: | | | | | | | |
| K: | 0.0000000E+00 | | | | | | |
| C1: | −4.1129400E−09 | C2: | −1.5968800E−13 | C3: | 2.2234300E−17 | C4: | −8.0417700E−23 |
| C5: | −2.8496200E−26 | C6: | 5.3591400E−31 | C7: | 0.0000000E+00 | C8: | 0.0000000E+00 |
| 49: | | | | | | | |
| K: | 0.0000000E+00 | | | | | | |
| C1: | 2.8208700E−08 | C2: | −6.3390900E−13 | C3: | −7.8724600E−17 | C4: | 1.0678900E−20 |
| C5: | −4.6025400E−25 | C6: | 8.0233400E−30 | C7: | 0.0000000E+00 | C8: | 0.0000000E+00 |
| 55: | | | | | | | |
| K: | 0.0000000E+00 | | | | | | |
| C1: | 3.5030100E−08 | C2: | 4.6510800E−12 | C3: | −1.0652400E−17 | C4: | −3.5325200E−21 |
| C5: | 1.0552200E−24 | C6: | −1.9607700E−29 | C7: | 0.0000000E+00 | C8: | 0.0000000E+00 |

TABLE 9
(Specifications for FIG. 18)

| SUB- | | | ORIENTATION OF |
|---|---|---|---|
| ELEMENT | MATERIAL | THICKNESS [mm] | THE CRYSTAL AXIS |
| 111b | MgF₂ | 0.072 | Parallel to the |
| | | | y-axis |
| 111a | SiO₂ | 4.5 | |
| 111c | MgF₂ | 0.072 | Parallel to the |
| | | | x-axis |

TABLE 10
(Specifications for FIG. 19)

| SUB- | | | ORIENTATION OF |
|---|---|---|---|
| ELEMENT | MATERIAL | THICKNESS [mm] | THE CRYSTAL AXIS |
| 112b | MgF₂ | 0.013 | 45° to the |
| | | | y-axis |
| 112a | SiO₂ | 3.5 | |
| 112c | MgF₂ | 0.013 | 45° to the |
| | | | x-axis |

TABLE 11
(Specifications for FIG. 20)

| SUB- | | | ORIENTATION OF |
|---|---|---|---|
| ELEMENT | MATERIAL | THICKNESS [mm] | THE CRYSTAL AXIS |
| 141b | MgF₂ | 0.017 | Parallel to |
| | | | y-axis |
| 141a | SiO₂ | 4.5 | |
| 141c | MgF₂ | 0.017 | Parallel to |
| | | | x-axis |

TABLE 12
(Specifications of the last lens in FIG. 16)

| | IBR | | | | | | | | |
|---|---|---|---|---|---|---|---|---|---|
| Surface | [nm/cm] | Material | Orientation | Y/alpha | Y/beta | Y/gamma | Z/alpha | Z/beta | Z/gamma |
| 56 | 30.1 | LuAG | 100 [0 degrees] | 0.000000 | 1.000000 | 0.000000 | −1.000000 | 0.000000 | 0.000000 |
| 57 | 30.1 | LuAG | 100 [0 degrees] | 0.000000 | 1.000000 | 0.000000 | −1.000000 | 0.000000 | 0.000000 |
| 58 | 30.1 | LuAG | 100 [45 degrees] | 0.707107 | 0.707107 | 0.000000 | −0.707107 | 0.707107 | 0.000000 |
| 59 | 30.1 | LuAG | 111 [0 degrees] | −0.707107 | 0.408248 | 0.577350 | 0.000000 | −0.816497 | 0.577350 |
| 60 | 30.1 | LuAG | 111 [60 degrees] | 0.000000 | 0.816497 | 0.577350 | −0.707107 | −0.408248 | 0.577350 |

1. A projection lens having an optical axis, the projection lens configured to image radiation from an object plane of the projection lens to an image plane of the projection lens, the projection lens comprising:
a last lens on an image plane side of the projection lens, the last lens comprising at least one intrinsically birefringent material selected from the group consisting of magnesium oxide, a garnet, lithium barium fluoride and a spinel,
wherein:
the last lens has a thickness d that satisfies the condition
0.8*y_{0,max}<d<1.5*y_{0,max},
where y_{0,max} is a maximum distance of an object field point from the optical axis; and the projection lens is configured to be used in a microlithographic projection exposure apparatus.

2. The projection lens according to claim 1, wherein the projection lens comprises at least one refractive subsystem and produces at least one intermediate image.

3. The projection lens according to claim 1, further comprising at least one concave mirror.

4. The projection lens according to claim 1, further comprising precisely two concave mirrors.

5. The projection lens according to claim 1, wherein the projection lens has a first purely refractive subsystem, a second subsystem with precisely two concave mirrors and a third purely refractive subsystem.

6. The projection lens according to claim 1, wherein:
the last lens comprises at least four lens elements of intrinsically birefringent material and arranged in succession along the optical axis; and
two respective lens elements of the four lens elements in pairs have the same crystal cut and are arranged rotated relative to each other about the optical axis.

7. The projection lens according to claim 6, wherein two of the four lens elements have a [111]-crystal cut and the other two lens elements of the four lens elements have a [100]-crystal cut.

8. A projection lens having an optical axis, the projection lens configured to image radiation from an object plane of the projection lens to an image plane of the projection lens, the projection lens comprising:
a plurality of refractive lenses of non-optically uniaxial material, at least one of the plurality of refractive lenses having intrinsic birefringence; and
at least two compensation elements configured to at least partial compensation of the intrinsic birefringence, each of the at least two compensation elements comprising a respective optically uniaxial crystal material,
wherein:
at least one of the at least two compensation elements does not introduce a retardation for light passing through in a direction of the optical axis; and
the at least two compensation elements are arranged along the optical axis at different positions, between which there is at least one of the plurality of refractive lenses.

9. The projection lens according to claim 8, wherein at least one of the at least two compensation elements has a plane-parallel geometry.

10. The projection lens according to claim 8, wherein the at least one of the plurality of refractive lenses having intrinsic birefringence comprises at least one material selected from the group consisting of magnesium oxide, a garnet, lithium barium fluoride and a spinel.

11. The projection lens according to claim 8, wherein the projection lens comprises a last lens on an image plane side, the last lens having a thickness d that satisfies the condition 0.8*y_{0, max}<d<1.5*y_{0, max}, where y_{0, max} denotes a maximum distance of an object field point from the optical axis.

12. The projection lens according to claim 8, wherein at least one of the at least two compensation elements comprises two plane-parallel subelements of optically uniaxial crystal material whose optical crystal axes are respectively arranged in a plane perpendicular to the optical axis and rotated relative to each other about the optical axis.

13. The projection lens according to claim 8, wherein at least one of the at least two compensation elements is arranged in a last optical subsystem on the image plane side of the projection lens.

14. The projection lens according to claim 8, wherein at least one of the at least two compensation elements is arranged at least in the proximity of a pupil plane of the projection lens.

15. The projection lens according to claim 8, wherein the at least two compensation elements comprise at least three compensation elements arranged along the optical axis.

16. The projection lens according to claim 8, wherein at least one of the at least two compensation elements comprises an optically uniaxial crystal material whose optical crystal axis is arranged parallel to the optical axis.

17. The projection lens according to claim 8, wherein during use at least one of the plurality refractive lenses causes a maximum retardation of at least 25 nm/cm as a consequence of intrinsic birefringence.

18. An apparatus, comprising:
an illumination system; and
a projection lens according to claim 8,
wherein the apparatus is a microlithographic projection exposure apparatus.

19. A process, comprising:
using the apparatus of claim 18 to project at least a part of a mask onto a region of a light sensitive layer.

20. An apparatus, comprising:
an illumination system; and
a projection lens according to claim 1,
wherein the apparatus is a microlithographic projection exposure apparatus.

21. The projection lens according to claim 1, wherein the at least one intrinsically birefringent material comprises a lutetium aluminum garnet.

22. The projection lens according to claim 1, wherein the at least one intrinsically birefringent material comprises a magnesium spinel.

23. The projection lens according to claim 12, wherein the plane-parallel subelements are rotated relative to each other about the optical axis at 90°.
